(19) United States
(12) Patent Application Publication
(10) Pub. No.: US 2007/0147502 A1
(43) Pub. Date: Jun. 28, 2007

(54) Method and apparatus for encoding and decoding picture signal, and related computer programs

(75) Inventor: Hiroya Nakamura, Kanagawa-ken (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 11/643,858

(22) Filed: Dec. 22, 2006

(30) Foreign Application Priority Data
Dec. 28, 2005 (JP) 2005-378005

(51) Int. Cl. H04N 7/12

(52) U.S. Cl. 375/240.12; 375/240.26

(57) ABSTRACT

A first-viewpoint picture is encoded. A first decoded picture is generated in the encoding of the first-viewpoint picture. A second-viewpoint picture is encoded. A second decoded picture is generated in the encoding of the second-viewpoint picture. View interpolation responsive to the first decoded picture and the second decoded picture is performed to generate a view-interpolated signal for every multi-pixel block. One is decided from different coding modes including coding modes relating to the view interpolation for every multi-pixel block. A prediction signal is generated in accordance with the decided coding mode. The prediction signal is subtracted from a third-viewpoint picture to generate a residual signal for every multi-pixel block. A signal representative of the decided coding mode and the residual signal are encoded to generate encoded data representing the third-viewpoint picture and containing the signal representative of the decided coding mode.

### BACKGROUND OF THE INVENTION

1. Field of the Invention

This invention relates to a method, an apparatus, and a computer program for encoding signals representative of multi-view video taken from multiple viewpoints. In addition, this invention relates to a method, an apparatus, and a computer program for decoding encoded data representative of multi-view video taken from multiple viewpoints.

2. Description of the Related Art

An MPEG (Moving Picture Experts Group) encoder compressively encodes a digital signal (data) representing a video sequence. The MPEG encoder performs motion-compensated prediction and orthogonal transform with respect to the video signal to implement highly efficient encoding and data compression. The motion-compensated prediction utilizes a temporal redundancy in the video signal for the data compression. The orthogonal transform utilizes a spatial redundancy in the video signal for the data compression. Specifically, the orthogonal transform is discrete cosine transform (DCT).

MPEG-2 Video (ISO/IEC 13818-2) established in 1995 prescribes the coding of a video sequence. MPEG-2 Video encoders and decoders can handle interlaced scanning pictures, progressive scanning pictures, SDTV (standard definition television) pictures, and HDTV (high definition television) pictures. The MPEG-2 Video encoders and decoders are used in various applications such as the recording and playback of data on and from a DVD or a D-VHS recording medium, and digital broadcasts.

MPEG-4 Visual (ISO/IEC 14496-2) established in 1998 prescribes the highly efficient coding of a video signal in applications such as network-based data transmission and portable terminal devices.

The standard called MPEG-4 AVC/H.264 (14496-10 in ISO/IEC, H.264 in ITU-T) has been established by the cooperation of ISO/IEC and ITU-T in 2003. MPEG-4 AVC/H.264 provides a higher coding efficiency than that of the MPEG-2 Video or the MPEG-4 Visual.

In a binocular stereoscopic television system, two cameras take pictures of a scene for viewer's left and right eyes (left and right views) in two different directions respectively, and the pictures are indicated on a common screen to present the stereoscopic pictures to a viewer. Generally, the left-view picture and the right-view picture are handled as independent pictures respectively. Accordingly, the transmission of a signal representing the left-view picture and the transmission of a signal representing the right-view picture are separate from each other. Similarly, the recording of a signal representing the left-view picture and the recording of a signal representing the right-view picture are separate from each other. When the left-view picture and the right-view picture are handled as independent pictures respectively, the necessary total amount of coded picture information is equal to about twice that of information representing only a monoscopic picture (a single two-dimensional picture).

There has been a proposed stereoscopic television system designed so as to reduce the total amount of coded picture information. In the proposed stereoscopic television system, one of left-view and right-view pictures is labeled as a base picture while the other is set as a sub picture.

Japanese patent application publication number 61-144191/1986 discloses a transmission system for stereoscopic pictures. In the system of Japanese application 61-144191/1986, each of left-view and right-view pictures is divided into equal-size small areas called blocks. One of the left-view and right-view pictures is referred to as the first picture while the other is called the second picture. A window equal in shape and size to one block is defined in the first picture. For every block of the second picture, the difference between a signal representing a first-picture portion filling the window and a signal representing the present block of the second picture is calculated as the window is moved throughout a given range centered at the first-picture block corresponding to the present block of the second picture. Detection is made as to the position of the window at which the calculated difference is minimized. The deviation of the detected window position from the position in the first-picture block corresponding to the present block of the second picture is labeled as a position change quantity.

In the system of Japanese application 61-144191/1986, the blocks constituting one of the left-view and right-view pictures are shifted in accordance with the position change quantities. A difference signal is generated which represents the difference between the block-shift-resultant picture and the other picture. The difference signal, information representing the position change quantities, and information representing one of the left-view and right-view pictures are transmitted.

Stereoscopic video coding called Multi-view Profile (ISO/IEC 13818-2/AMD3) has been added to MPEG-2 Video (ISO/IEC 13818-2) in 1996. The MPEG-2 Video Multi-view Profile is 2-layer coding. A base layer of the Multi-view Profile is assigned to a left view, and an enhancement layer is assigned to a right view. The MPEG-2 Video Multi-view Profile implements the coding of stereoscopic video data by steps including motion-compensated prediction, discrete cosine transform, and disparity-compensated prediction. The motion-compensated prediction utilizes a temporal redundancy in the stereoscopic video data for the data compression. The discrete cosine transform utilizes a spatial redundancy in the stereoscopic video data for the data compression. The disparity-compensated prediction utilizes an inter-view redundancy in the stereoscopic video data for the data compression.

Japanese patent application publication number 2004-48725 corresponding to U.S. Pat. No. 6,163,337 discloses first and second systems which are a multi-view video transmission system and a multi-viewpoint image transmission system respectively. The first system includes a sending side and a receiving side. The sending side selects two non-adjacent viewpoints from multiple viewpoints, and encodes the pictures for the two selected viewpoints into the bitstreams for the two selected viewpoints. The sending side obtains the decoded pictures by decoding the bitstreams for the two selected viewpoints. The sending side generates intermediate-viewpoint pictures from the two decoded pictures for the two selected viewpoints. The generated intermediate-viewpoint pictures correspond to the respective multiple viewpoints except the two selected viewpoints. The sending side computes residuals between the intermediate-viewpoint pictures and the corresponding original pictures. The sending side compressively encodes the computed residuals into the bitstreams for the intermediate viewpoints. The encoded bitstreams for the two selected viewpoints and the intermediate viewpoints are transmitted from the sending side to the receiving side.

In the first system of Japanese application 2004-48725, the receiving side expansively decodes the bitstreams for the two selected viewpoints and intermediate viewpoints into the decoded pictures for the two selected viewpoints and the residuals for the intermediate viewpoints. The receiving side generates intermediate-viewpoint pictures from the two decoded pictures for the two selected viewpoints. The generated intermediate-viewpoint pictures correspond to the respective multiple viewpoints except the two selected viewpoints. The receiving side superimposes the decoded residuals on the intermediate-viewpoint pictures, and thereby reproduces the multiple pictures except the two selected pictures. As a result, the receiving side reproduces all the multiple pictures.

The second system of Japanese application 2004-48725 includes a sending side and a receiving side. The sending side selects two non-adjacent-viewpoint images from multi-ocular images, and generates intermediate-viewpoint images from the two selected images. The generated intermediate-viewpoint images correspond to the respective multi-ocular images except the two selected images. The sending side computes residuals between the intermediate-viewpoint images and the corresponding multi-ocular images. The sending side compressively encodes one of the two selected images, and the computed residuals. The sending side obtains a relative parallax between the two selected images, and also a prediction error therebetween. The sending side compressively encodes the obtained parallax and the obtained prediction error. The encoded image, the encoded residuals, the encoded parallax, and the encoded prediction error are transmitted from the sending side to the receiving side.

In the second system of Japanese application 2004-48725, the receiving side expansively decodes the encoded image, the encoded parallax, and the encoded prediction error, and thereby reproduces the two selected images. The receiving side generates intermediate-viewpoint images from the two reproduced images. The generated intermediate-viewpoint images correspond to the respective multi-ocular images except the two selected images. The receiving side expansively decodes the encoded residuals in response to the intermediate-viewpoint images, and thereby reproduces the multi-ocular images except the two selected images. As a result, the receiving side reproduces all the multi-ocular images.

Japanese patent application publication number 10-13860/1998 discloses a stereoscopic picture interpolation apparatus which responds to left-view and right-view pictures taken from two different viewpoints. In the apparatus, interpolation responsive to the left-view and right-view pictures is performed to generate an interpolated picture corresponding to a viewpoint between the two different viewpoints.

Specifically, the apparatus of Japanese application 10-13860/1998 includes a disparity vector estimator, a disparity quantity calculator, a picture shifter, and a multiplier/adder. The disparity vector estimator sets a search range for disparity vectors in accordance with the distance between the viewpoints relating to the left-view and right-view pictures respectively. The disparity vector estimator obtains disparity vectors within the search range which represent a positional difference between the patterns of the left-view and right-view pictures. For each of blocks constituting one picture, the disparity quantity calculator computes desired disparity quantities for the left-view and right-view pictures from the disparity vectors and a positional relation among a viewpoint concerning an interpolated picture and the viewpoints concerning the left-view and right-view pictures. For each of blocks constituting one picture, the picture shifter moves the left-view and right-view pictures by the desired disparity quantities to generate moved left-view and right-view pictures. The multiplier/adder multiplies the moved left-view and right-view pictures by coefficients depending on a positional relation among the interpolated picture and the left-view and right-view pictures. The multiplier/adder adds the results of the multiplications to generate the interpolated picture.

The previously-mentioned system of Japanese application 61-144191/1986 requires the transmission of the information representing the position change quantities in addition to the transmission of the difference signal and the information representing one of the left-view and right-view pictures. The transmission of the information representing the position change quantities would cause a reduction in system transmission efficiency or system coding efficiency.

The previously-mentioned system of Japanese application 2004-48725 tends to drop in coding efficiency in the case where the angular intervals of the viewpoints are relatively great so that the disparities are also large. The large disparities might cause interpolation for generating the intermediate-viewpoint pictures to be wrong. Thus, the large disparities might cause a lot of errors in the computed residuals.

### SUMMARY OF THE INVENTION

It is a first object of this invention to provide an apparatus for encoding signals representative of multi-view video with a higher degree of efficiency.

It is a second object of this invention to provide a method of encoding signals representative of multi-view video with a higher degree of efficiency.

It is a third object of this invention to provide a computer program for encoding signals representative of multi-view video with a higher degree of efficiency.

It is a fourth object of this invention to provide an apparatus for decoding efficiently-encoded data representative of multi-view video.

It is a fifth object of this invention to provide a method of decoding efficiently-encoded data representative of multi-view video.

It is a sixth object of this invention to provide a computer program for decoding efficiently-encoded data representative of multi-view pictures.

A first aspect of this invention provides an apparatus for encoding pictures taken from multiple viewpoints. The apparatus comprises first means for encoding a picture taken from a first viewpoint; second means provided in the first means for generating a first decoded picture in the encoding by the first means; third means for encoding a picture taken from a second viewpoint different from the first viewpoint; fourth means provided in the third means for generating a second decoded picture in the encoding by the third means; fifth means for performing view interpolation responsive to the first decoded picture generated by the second means and the second decoded picture generated by the fourth means to generate a view-interpolated signal for every multi-pixel block; sixth means for deciding one from different coding modes including coding modes relating to the view interpolation performed by the fifth means for every multi-pixel block; seventh means for generating a prediction signal in accordance with the coding mode decided by the sixth means for every multi-pixel block; eighth means for subtracting the prediction signal generated by the seventh means from a picture taken from a third viewpoint to generate a residual signal for every multi-pixel block, the third viewpoint being different from the first and second viewpoints; and ninth means for encoding a signal representative of the coding mode decided by the sixth means and the residual signal generated by eighth means to generate encoded data representing the picture taken from the third viewpoint and containing the signal representative of the decided coding mode.

A second aspect of this invention provides a method of encoding pictures taken from multiple viewpoints. The method comprises the steps of encoding a picture taken from a first viewpoint; generating a first decoded picture in the encoding of the picture taken from the first viewpoint; encoding a picture taken from a second viewpoint different from the first viewpoint; generating a second decoded picture in the encoding of the picture taken from the second viewpoint; performing view interpolation responsive to the first decoded picture and the second decoded picture to generate a view-interpolated signal for every multi-pixel block; deciding one from different coding modes including coding modes relating to the view interpolation for every multi-pixel block; generating a prediction signal in accordance with the decided coding mode for every multi-pixel block; subtracting the prediction signal from a picture taken from a third viewpoint to generate a residual signal for every multi-pixel block, the third viewpoint being different from the first and second viewpoints; and encoding a signal representative of the decided coding mode and the residual signal to generate encoded data representing the picture taken from the third viewpoint and containing the signal representative of the decided coding mode.

A third aspect of this invention provides a computer program in a computer readable medium. The computer program comprises the steps of encoding a picture taken from a first viewpoint; generating a first decoded picture in the encoding of the picture taken from the first viewpoint; encoding a picture taken from a second viewpoint different from the first viewpoint; generating a second decoded picture in the encoding of the picture taken from the second viewpoint; performing view interpolation responsive to the first decoded picture and the second decoded picture to generate a view-interpolated signal for every multi-pixel block; deciding one from different coding modes including coding modes relating to the view interpolation for every multi-pixel block; generating a prediction signal in accordance with the decided coding mode for every multi-pixel block; subtracting the prediction signal from a picture taken from a third viewpoint to generate a residual signal for every multi-pixel block, the third viewpoint being different from the first and second viewpoints; and encoding a signal representative of the decided coding mode and the residual signal to generate encoded data representing the picture taken from the third viewpoint and containing the signal representative of the decided coding mode.

A fourth aspect of this invention is based on the first aspect thereof, and provides an apparatus further comprising a buffer memory for storing the first and second decoded pictures.

A fifth aspect of this invention is based on the second aspect thereof, and provides a method further comprising the step of storing the first and second decoded pictures in a buffer memory.

A sixth aspect of this invention is based on the third aspect thereof, and provides a computer program further comprising the step of storing the first and second decoded pictures in a buffer memory.

A seventh aspect of this invention is based on the first aspect thereof, and provides an apparatus wherein the different coding modes include coding modes performing motion-compensated prediction for every multi-pixel block.

An eighth aspect of this invention is based on the second aspect thereof, and provides a method wherein the different coding modes include coding modes performing motion-compensated prediction for every multi-pixel block.

A ninth aspect of this invention is based on the third aspect thereof, and provides a computer program wherein the different coding modes include coding modes performing motion-compensated prediction for every multi-pixel block.

A tenth aspect of this invention is based on the first aspect thereof, and provides an apparatus wherein the different coding modes include coding modes performing disparity-compensated prediction for every multi-pixel block.

An eleventh aspect of this invention is based on the second aspect thereof, and provides a method wherein the different coding modes include coding modes performing disparity-compensated prediction for every multi-pixel block.

A twelfth aspect of this invention is based on the third aspect thereof, and provides a computer program wherein the different coding modes include coding modes performing disparity-compensated prediction for every multi-pixel block.

A thirteenth aspect of this invention is based on the first aspect thereof, and provides an apparatus wherein the different coding modes include coding modes which use multi-pixel blocks of different sizes respectively.

A fourteenth aspect of this invention is based on the second aspect thereof, and provides a method wherein the different coding modes include coding modes which use multi-pixel blocks of different sizes respectively.

A fifteenth aspect of this invention is based on the third aspect thereof, and provides a computer program wherein the different coding modes include coding modes which use multi-pixel blocks of different sizes respectively.

A sixteenth aspect of this invention is based on the first aspect thereof, and provides an apparatus wherein the different coding modes include coding modes performing a process of weighted-averaging view interpolation and motion-compensated prediction.

A seventeenth aspect of this invention is based on the second aspect thereof, and provides a method wherein the different coding modes include coding modes performing a process of weighted-averaging view interpolation and motion-compensated prediction.

An eighteenth aspect of this invention is based on the third aspect thereof, and provides a computer program wherein the different coding modes include coding modes performing a process of weighted-averaging view interpolation and motion-compensated prediction.

A nineteenth aspect of this invention is based on the first aspect thereof, and provides an apparatus wherein the different coding modes include coding modes performing a process of weighted-averaging view interpolation and disparity-compensated prediction.

A twentieth aspect of this invention is based on the second aspect thereof, and provides a method wherein the different coding modes include coding modes performing a process of weighted-averaging view interpolation and disparity-compensated prediction.

A twenty-first aspect of this invention is based on the third aspect thereof, and provides a computer program wherein the different coding modes include coding modes performing a process of weighted-averaging view interpolation and disparity-compensated prediction.

A twenty-second aspect of this invention provides an apparatus for decoding encoded data representing pictures taken from multiple viewpoints. The apparatus comprises first means for decoding encoded data representative of a picture taken from a first viewpoint to generate a first decoded picture; second means for decoding encoded data representative of a picture taken from a second viewpoint to generate a second decoded picture, the second viewpoint being different from the first viewpoint; third means for decoding encoded data containing a residual signal representative of a picture taken from a third viewpoint to generate a decoded residual signal, the third viewpoint being different from the first and second viewpoints; fourth means for decoding encoded data containing a signal representative of a decided coding mode which has been decided from different coding modes to detect the decided coding mode for every multi-pixel block; fifth means for performing view interpolation responsive to the first decoded picture generated by the first means and the second decoded picture generated by the second means to generate a view-interpolated signal for every multi-pixel block when the decided coding mode indicates use of view interpolation; sixth means for generating a prediction signal on the basis of the view-interpolated signal generated by the fifth means in accordance with the decided coding mode for every multi-pixel block; and seventh means for superimposing the decoded residual signal generated by the third means on the prediction signal generated by the sixth means to generate a third decoded picture equivalent to the picture taken from the third viewpoint.

A twenty-third aspect of this invention provides a method of decoding encoded data representing pictures taken from multiple viewpoints. The method comprises the steps of decoding encoded data representative of a picture taken from a first viewpoint to generate a first decoded picture; decoding encoded data representative of a picture taken from a second viewpoint to generate a second decoded picture, the second viewpoint being different from the first viewpoint; decoding encoded data containing a residual signal representative of a picture taken from a third viewpoint to generate a decoded residual signal, the third viewpoint being different from the first and second viewpoints; decoding encoded data containing a signal representative of a decided coding mode which has been decided from different coding modes to detect the decided coding mode for every multi-pixel block; performing view interpolation responsive to the first decoded picture and the second decoded picture to generate a view-interpolated signal for every multi-pixel block when the decided coding mode indicates use of view interpolation; generating a prediction signal on the basis of the view-interpolated signal in accordance with the decided coding mode for every multi-pixel block; and superimposing the decoded residual signal on the generated prediction signal to generate a third decoded picture equivalent to the picture taken from the third viewpoint.

A twenty-fourth aspect of this invention provides a computer program in a computer readable medium. The computer program comprises the steps of decoding encoded data representative of a picture taken from a first viewpoint to generate a first decoded picture; decoding encoded data representative of a picture taken from a second viewpoint to generate a second decoded picture, the second viewpoint being different from the first viewpoint; decoding encoded data containing a residual signal representative of a picture taken from a third viewpoint to generate a decoded residual signal, the third viewpoint being different from the first and second viewpoints; decoding encoded data containing a signal representative of a decided coding mode which has been decided from different coding modes to detect the decided coding mode for every multi-pixel block; performing view interpolation responsive to the first decoded picture and the second decoded picture to generate a view-interpolated signal for every multi-pixel block when the decided coding mode indicates use of view interpolation; generating a prediction signal on the basis of the view-interpolated signal in accordance with the decided coding mode for every multi-pixel block; and superimposing the decoded residual signal on the generated prediction signal to generate a third decoded picture equivalent to the picture taken from the third viewpoint.

A twenty-fifth aspect of this invention is based on the twenty-second aspect thereof, and provides an apparatus further comprising a buffer memory for storing the first and second decoded pictures.

A twenty-sixth aspect of this invention is based on the twenty-third aspect thereof, and provides a method further comprising the step of storing the first and second decoded pictures in a buffer memory.

A twenty-seventh aspect of this invention is based on the twenty-fourth aspect thereof, and provides a computer program further comprising the step of storing the first and second decoded pictures in a buffer memory.

A twenty-eighth aspect of this invention is based on the twenty-second aspect thereof, and provides an apparatus wherein the different coding modes include coding modes performing motion-compensated prediction for every multi-pixel block.

A twenty-ninth aspect of this invention is based on the twenty-third aspect thereof, and provides a method wherein the different coding modes include coding modes performing motion-compensated prediction for every multi-pixel block.

A thirtieth aspect of this invention is based on the twenty-fourth aspect thereof, and provides a computer program wherein the different coding modes include coding modes performing motion-compensated prediction for every multi-pixel block.

A thirty-first aspect of this invention is based on the twenty-second aspect thereof, and provides an apparatus wherein the different coding modes include coding modes performing disparity-compensated prediction for every multi-pixel block.

A thirty-second aspect of this invention is based on the twenty-third aspect thereof, and provides a method wherein the different coding modes include coding modes performing disparity-compensated prediction for every multi-pixel block.

A thirty-third aspect of this invention is based on the twenty-fourth aspect thereof, and provides a computer program wherein the different coding modes include coding modes performing disparity-compensated prediction for every multi-pixel block.

A thirty-fourth aspect of this invention is based on the twenty-second aspect thereof, and provides an apparatus wherein the different coding modes include coding modes which use multi-pixel blocks of different sizes respectively.

A thirty-fifth aspect of this invention is based on the twenty-third aspect thereof, and provides a method wherein the different coding modes include coding modes which use multi-pixel blocks of different sizes respectively.

A thirty-sixth aspect of this invention is based on the twenty-fourth aspect thereof, and provides a computer program wherein the different coding modes include coding modes which use multi-pixel blocks of different sizes respectively.

A thirty-seventh aspect of this invention is based on the twenty-second aspect thereof, and provides an apparatus wherein the different coding modes include coding modes performing a process of weighted-averaging view interpolation and motion-compensated prediction.

A thirty-eighth aspect of this invention is based on the twenty-third aspect thereof, and provides a method wherein the different coding modes include coding modes performing a process of weighted-averaging view interpolation and motion-compensated prediction.

A thirty-ninth aspect of this invention is based on the twenty-fourth aspect thereof, and provides a computer program wherein the different coding modes include coding modes performing a process of weighted-averaging view interpolation and motion-compensated prediction.

A fortieth aspect of this invention is based on the twenty-second aspect thereof, and provides an apparatus wherein the different coding modes include coding modes performing a process of weighted-averaging view interpolation and disparity-compensated prediction.

A forty-first aspect of this invention is based on the twenty-third aspect thereof, and provides a method wherein the different coding modes include coding modes performing a process of weighted-averaging view interpolation and disparity-compensated prediction.

A forty-second aspect of this invention is based on the twenty-fourth aspect thereof, and provides a computer program wherein the different coding modes include coding modes performing a process of weighted-averaging view interpolation and disparity-compensated prediction.

This invention has an advantage mentioned below. In this invention, multi-view video is encoded through signal processing which includes view interpolation. The view interpolation generates a prediction signal (a view-interpolated signal) for a picture of interest which relates to one viewpoint on the basis of reference pictures relating to other viewpoints. The reference pictures are those resulting from encoding and decoding original pictures relating to the other viewpoints. The view interpolation does not require the encoding of information representing vectors such as motion vectors and disparity vectors. The view interpolation is applied to a multi-pixel block where a correlation among pictures taken from the respective viewpoints is high so that the prediction signal (the view-interpolated signal) can be good. The application of the view interpolation to such a multi-pixel block causes a high coding efficiency.

### BRIEF DESCRIPTION OF THE DRAWINGS

FIG. 1 is a diagram showing an example of a sequence of pictures for left view and a sequence of pictures for right view which are compressively encoded by a first prior-art system conforming to the MPEG-2 Video Multi-view Profile.

FIG. 2 is a block diagram of the sending side of a second prior-art system operating as a compressive transmission system for multi-view video.

FIG. 3 is a block diagram of the receiving side of the second prior-art system.

FIG. 4 is a block diagram of a multi-view video encoding apparatus in a system according to a first embodiment of this invention.

FIG. 5 is a diagram showing multiple video sequences and an example of the relation in prediction among pictures in the video sequences.

FIG. 6 is a block diagram of a picture encoding section in the encoding apparatus of FIG. 4.

FIG. 7 is a diagram showing conditions of block-matching-based view interpolation for generating an interpolated picture from two reference pictures.

FIG. 8 is a block diagram of a multi-view video decoding apparatus in the system according to the first embodiment of this invention.

FIG. 9 is a block diagram of a picture decoding section in the decoding apparatus of FIG. 8.

FIG. 10 is a block diagram of a multi-view video encoding apparatus in a system according to a second embodiment of this invention.

FIG. 11 is a flowchart of a segment of a control program for a computer system in FIG. 10.

FIG. 12 is a block diagram of a multi-view video decoding apparatus in the system according to the second embodiment of this invention.

FIG. 13 is a flowchart of a segment of a control program for a computer system in FIG. 12.

FIG. 14 is a block diagram of a multi-view video encoding apparatus in a system according to a third embodiment of this invention.

FIG. 15 is a block diagram of a multi-view video decoding apparatus in a system according to a fourth embodiment of this invention.

### DETAILED DESCRIPTION OF THE INVENTION

Prior-art systems will be explained below for a better understanding of this invention.

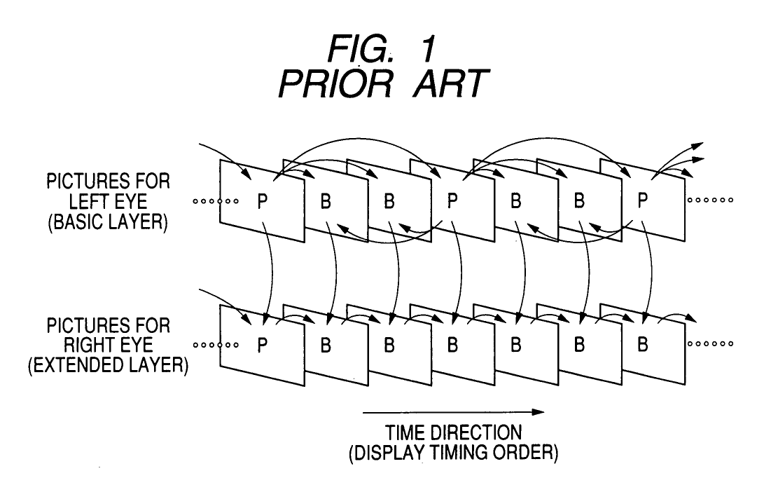

FIG. 1 shows an example of a sequence of pictures for left view and a sequence of pictures for right view which are compressively encoded by a first prior-art system conforming to the MPEG-2 Video Multi-view Profile. The encoding by the first prior-art system includes motion-compensated prediction and disparity-compensated prediction. In FIG. 1, conditions of the motion-compensated prediction and the disparity-compensated prediction are denoted by arrows. Specifically, a picture at which the starting point of an arrow exists is used as a reference picture by the motion-compensated prediction or the disparity-compensated prediction in the encoding/decoding of a picture denoted by the ending/decoding point of the arrow.

In FIG. 1, the left-view pictures are subjected to ordinary MPEG-2 Video coding which includes the motion-compensated prediction only. The ordinary MPEG-2 Video coding is for monoscopic pictures, and is also called the MPEG2 Video Main Profile to be distinguished from the MPEG-2 Video Multi-view Profile. Every P-picture among the right-view pictures is encoded through the use of the disparity-compensated prediction based on the left-view picture same in display timing as the present right-view P-picture. Every B-picture among the right-view pictures is encoded through the use of both the motion-compensated prediction based on the right-view picture immediately preceding the present right-view B-picture and the disparity-compensated prediction based on the left-view picture same in display timing as the present right-view B-picture.

The MPEG-2 Video Main Profile prescribes bidirectional prediction referring to past and future pictures. The MPEG-2 Video Multi-view Profile is similar to the MPEG-2 Video Main Profile except that the definition of prediction vectors is changed to cause the prediction in the coding of every right-view B picture to be in two directions for referring to a past right-view picture and a left-view picture. According to the MPEG-2 Video Multi-view Profile, the residuals occurring after the prediction concerning the sequence of the right-view pictures are subjected to DCT (discrete cosine transform), quantization, and variable length coding to form a coded bitstream representing the sequence of the original pictures. The bitstream is a compressed version of the original picture data.

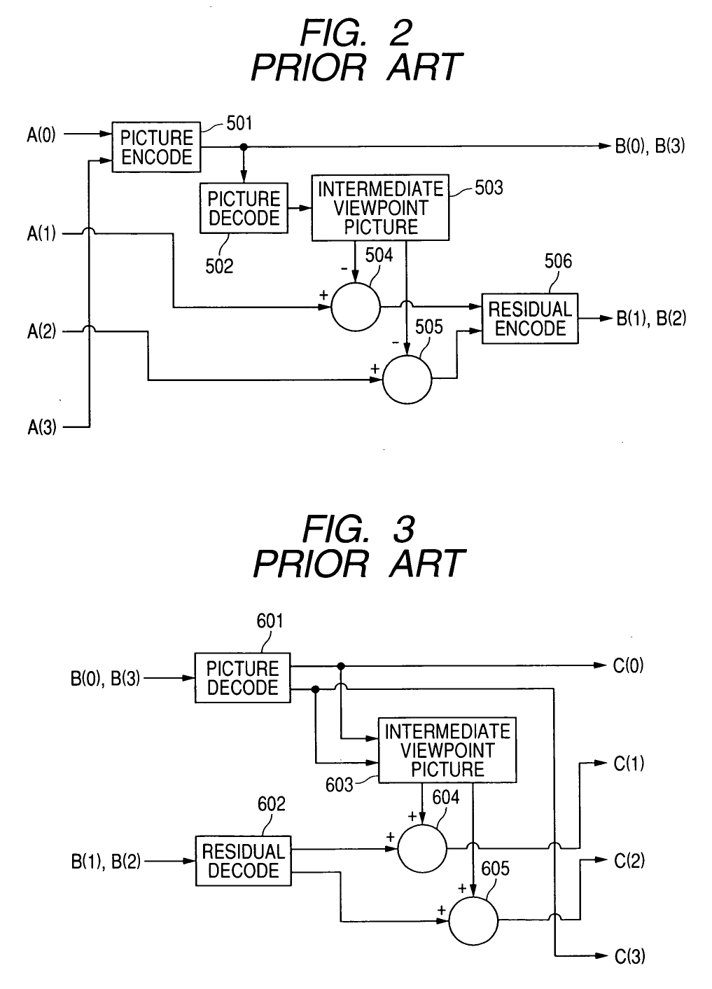

FIG. 2 shows the sending side of a second prior-art system operating as a compressive transmission system for multi-view video. As shown in FIG. 2, the sending side of the second prior-art system includes a picture compressively-encoding section 501, a picture decoding and expanding section 502, an intermediate-viewpoint-picture generating section 503, residual calculating sections (subtracters) 504 and 505, and a residual compressively-encoding section 506.

With reference to FIG. 2, there are a video sequence A(0) of pictures taken from a first viewpoint, a video sequence A(1) of pictures taken from a second viewpoint, a video sequence A(2) of pictures taken from a third viewpoint, and a video sequence A(3) of pictures taken from a fourth viewpoint. The first, second, third, and fourth viewpoints are sequentially arranged in that order. The sending side of the second prior-art system compressively encodes the video sequences A(0), A(1), A(2), and A(3) into bitstreams B(0), B(1), B(2), and B(3) respectively. The bitstream B(0) represents the pictures taken from the first viewpoint. The bitstream B(1) represents the pictures taken from the second viewpoint. The bitstream B(2) represents the pictures taken from the third viewpoint. The bitstream B(3) represents the pictures taken from the fourth viewpoint. The sending side of the second prior-art system sends the bitstreams B(0), B(1), B(2), and B(3).

The picture compressively-encoding section 501 compressively encodes the video sequences A(0) and A(3) into the bitstreams B(0) and B(3) through the use of a known technique such as MPEG-based one. The picture decoding and expanding section 502 expansively decodes the bitstreams B(0) and B(3) into video sequences C(0) and C(3) equivalent to the respective video sequences A(0) and A(3). The intermediate-viewpoint-picture generating section 503 estimates interpolated video sequences D(1) and D(2), which correspond to the respective video sequences A(1) and A(2), from the decoded video sequences C(0) and C(3) through the use of interpolation. The residual calculating section 504 subtracts the interpolated video sequence D(1) from the original video sequence A(1) to generate a first residual signal. The first residual signal indicates an error between the interpolated video sequence D(1) and the original video sequence A(1). The residual calculating section 505 subtracts the interpolated video sequence D(2) from the original video sequence A(2) to generate a second residual signal. The second residual signal indicates an error between the interpolated video sequence D(2) and the original video sequence A(2). The residual compressively-encoding section 506 compressively encodes the first and second residual signals into the bitstreams B(1) and B(2).

FIG. 3 shows the receiving side of the second prior-art system which receives the bitstreams B(0), B(1), B(2), and B(3). As shown in FIG. 3, the receiving side of the second prior-art system includes a picture decoding and expanding section 601, a residual decoding and expanding section 602, an intermediate-viewpoint-picture generating section 603, and residual-signal superimposing sections (adders) 604 and 605.

With reference to FIG. 3, the picture decoding and expanding section 601 expansively decodes the bitstreams B(0) and B(3) into decoded video sequences C(0) and C(3) through the use of a known technique such as MPEG-based one. The decoded video sequences C(0) and C(3) are the same as those in the sending side. The decoded video sequences C(0) and C(3) are equivalent to the respective video sequences A(0) and A(3), and are used as reproduced versions of the video sequences A(0) and A(3) respectively. The residual decoding and expanding section 602 expansively decodes the bitstreams B(1) and B(2) into the first and second residual signals same as those in the sending side respectively. The intermediate-viewpoint-picture generating section 603 estimates interpolated video sequences D(1) and D(2), which correspond to the respective video sequences A(1) and A(2), from the decoded video sequences C(0) and C(3) through the use of interpolation. This estimation is the same as that in the sending side, and therefore the interpolated video sequences D(1) and D(2) are the same as those in the sending side. The residual-signal superimposing section 604 superimposes the first residual signal on the interpolated video sequence D(1) to generate a decoded video sequence C(1) equivalent to the video sequence A(1). The decoded video sequence C(1) is used as a reproduced version of the video sequence A(1). The residual-signal superimposing section 605 superimposes the second residual signal on the interpolated video sequence D(2) to generate a decoded video sequence C(2) equivalent to the video sequence A(2). The decoded video sequence C(2) is used as a reproduced version of the video sequence A(2).

### First Embodiment

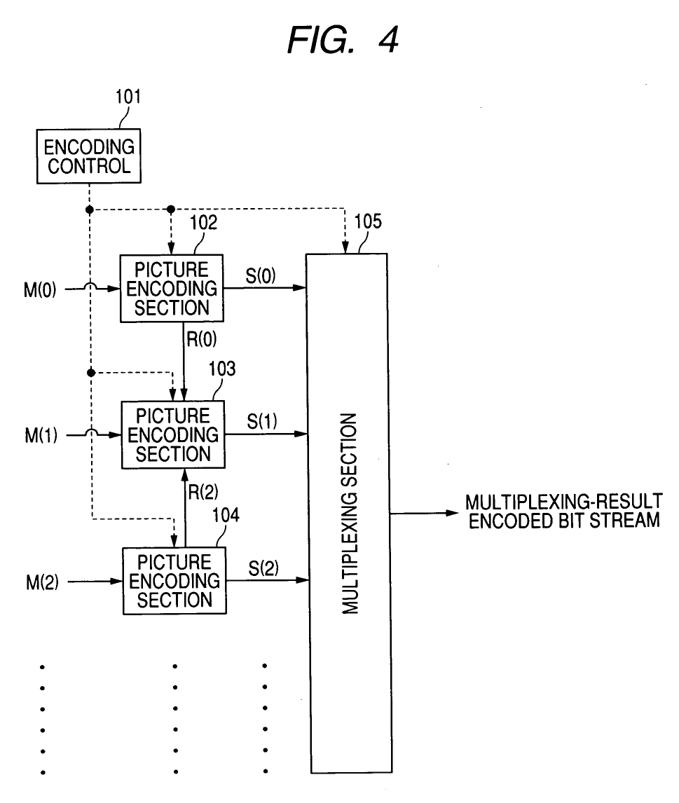

FIG. 4 shows a multi-view video encoding apparatus in a system according to a first embodiment of this invention. The encoding apparatus of FIG. 4 includes an encoding control section 101, picture encoding sections 102, 103, and 104, and a multiplexing section 105.

With reference to FIG. 4, there are data or a signal M(0) representing a sequence of pictures taken from a first viewpoint, data or a signal M(1) representing a sequence of pictures taken from a second viewpoint, and data or a signal M(2) representing a sequence of pictures taken from a third viewpoint. For an easier understanding, the data or signal M(0) is also referred to as the video sequence M(0) or the first-viewpoint video sequence M(0). The data or signal M(1) is also referred to as the video sequence M(1) or the second-viewpoint video sequence M(1). The data or signal M(2) is also referred to as the video sequence M(2) or the third-viewpoint video sequence M(2). The first, second, and third viewpoints differ from each other, and are sequentially arranged in that order. Pictures in each of the video sequences M(0), M(1), and M(2) are arranged in a display timing order.

For an easier understanding, data or a signal representing a picture is also referred to as a picture. Similarly, data or a signal representing a motion vector or vectors is also referred to as a motion vector or vectors. Data or a signal representing a disparity vector or vectors is also referred to as a disparity vector or vectors.

The encoding apparatus of FIG. 4 compressively encodes the video sequences M(0), M(1), and M(2) into first-viewpoint, second-viewpoint, and third-viewpoint bitstreams S(0), S(1), and S(2). Specifically, the picture encoding section 102 compressively encodes the first-viewpoint video sequence M(0) into the first-viewpoint bitstream S(0). The picture encoding section 103 compressively encodes the second-viewpoint video sequence M(1) into the second-viewpoint bitstream S(1). The picture encoding section 104 compressively encodes the third-viewpoint video sequence M(2) into the third-viewpoint bitstream S(2). The first-viewpoint bitstream S(0) represents the pictures taken from the first viewpoint. The second-viewpoint bitstream S(1) represents the pictures taken from the second viewpoint. The third-viewpoint bitstream S(2) represents the pictures taken from the third viewpoint.

There may be more than three video sequences relating to multiple viewpoints. In this case, the encoding apparatus of FIG. 4 compressively encodes more than three video sequences into bitstreams respectively. Furthermore, the encoding apparatus of FIG. 4 includes more than three picture encoding sections assigned to the respective video sequences.

The encoding control section 101 decides an order (a picture encoding order) in which pictures constituting the first-viewpoint video sequence M(0) should be encoded, an order (a picture encoding order) in which pictures constituting the second-viewpoint video sequence M(1) should be encoded, and an order (a picture encoding order) in which pictures constituting the third-viewpoint video sequence M(2) should be encoded. The encoding control section 101 decides whether or not motion-compensated prediction should be performed for the encoding of every picture, that is, the encoding of data representing every picture, in the video sequences M(0), M(1), and M(2). For the encoding of a picture relating to a viewpoint, the motion-compensated prediction uses a decoded picture or pictures (a decoded picture or pictures) relating to the same viewpoint as a reference picture or pictures. The encoding control section 101 decides whether or not disparity-compensated prediction should be performed for the encoding of every picture in the video sequences M(0), M(1), and M(2). For the encoding of a picture relating to a viewpoint, the disparity-compensated prediction uses decoded pictures relating to other viewpoints as reference pictures. The encoding control section 101 decides whether or not view interpolation should be performed for the encoding of every picture in the video sequences M(0), M(1), and M(2). For the encoding of a picture relating to a viewpoint, the view interpolation uses decoded pictures relating to other viewpoints as reference pictures. The encoding control section 101 decides whether or not a decoded picture resulting from the decoding of an encoded picture and relating to a viewpoint should be used as a reference picture for the encoding of a picture relating to another viewpoint. The encoding control section 101 decides which one or ones of candidate reference pictures should be selected as a final reference picture or pictures. In addition, the encoding control section 101 controls the picture encoding sections 102, 103, and 104.

Preferably, selected pictures in the video sequences M(0) and M(2) are used as reference pictures for the encoding of the video sequence M(1). Preferably, the encoding of the video sequence M(0) does not use reference pictures originating from the video sequences M(1) and M(2). Similarly, the encoding of the video sequence M(2) does not use reference pictures originating from the video sequences M(0) and M(1).

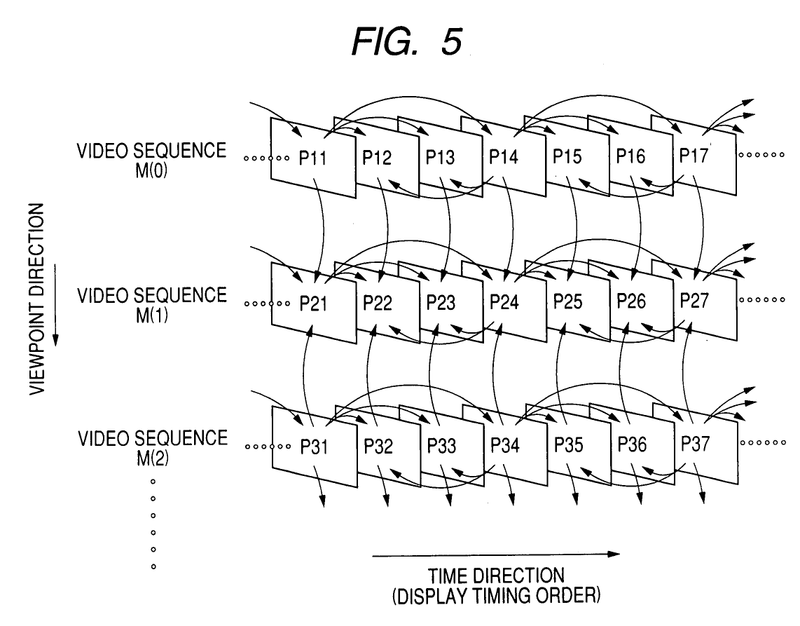

FIG. 5 shows an example of the relation in prediction among pictures in the video sequences M(0), M(1), and M(2) which occurs during the encoding of the video sequences M(0), M(1), and M(2). The encoding of the video sequences M(0), M(1), and M(2) includes motion-compensated prediction and disparity-compensated prediction. In FIG. 5, conditions of the motion-compensated prediction and the disparity-compensated prediction are denoted by arrows. Specifically, a picture at which the starting point of an arrow exists is used as a reference picture by the motion-compensated prediction or the disparity-compensated prediction in the encoding of a picture denoted by the ending point of the arrow.

With reference to FIGS. 4 and 5, the picture encoding section 102 compressively encodes the first-viewpoint video sequence M(0) without referring to pictures in the other video sequences M(1) and M(2). Similarly, the picture encoding section 104 compressively encodes the third-viewpoint video sequence M(2) without referring to pictures in the other video sequences M(0) and M(1). The encoding of the video sequences M(0) and M(2) by the picture encoding sections 102 and 104 is accorded with an ordinary encoding scheme using motion-compensated prediction. Examples of the ordinary encoding scheme are MPEG-2, MPEG-4, and AVC/H.264.

In FIG. 5, the first-viewpoint video sequence M(0) includes successive pictures P11, P12, P13, P14, P15, P16, and P17. The picture P14 is of the P type (a P picture) which is encoded on the basis of prediction using only one reference picture. Specifically, the picture P14 is encoded through motion-compensated prediction in which a decoded picture originating from the picture P11 is used as a reference picture. The picture P12 is of the B type (a B picture) which is encoded on the basis of prediction using two reference pictures. Specifically, the picture P12 is encoded through motion-compensated prediction in which decoded pictures originating from the pictures P11 and P14 are used as reference pictures. In FIG. 5, the third-viewpoint video sequence M(2) includes successive pictures P31, P32, P33, P34, P35, P36, and P37.

With reference to FIGS. 4 and 5, the picture encoding section 103 compressively encodes the second-viewpoint video sequence M(1) through disparity-compensated prediction and view interpolation in addition to motion-compensated prediction. The disparity-compensated prediction and the view interpolation refer to reference pictures R(0) and R(2) originating from the other video sequences M(0) and M(2).

In FIG. 5, the second-viewpoint video sequence M(1) includes successive pictures P21, P22, P23, P24, P25, P26, and P27. The pictures P21, P22, P23, P24, P25, P26, and P27 are equal in display timing to the pictures P11, P12, P13, P14, P15, P16, and P17 in the first-viewpoint video sequence M(0), respectively. Furthermore, the pictures P21, P22, P23, P24, P25, P26, and P27 are equal in display timing to the pictures P31, P32, P33, P34, P35, P36, and P37 in the third-viewpoint video sequence M(2), respectively. The picture P22 is encoded through (1) motion-compensated prediction in which decoded pictures originating from the same-viewpoint pictures P21 and P24 are used as reference pictures, and (2) disparity-compensated prediction and view interpolation in which decoded pictures originating from the other-viewpoint pictures P12 and P32 are used as reference pictures. An overall picture encoding order is designed so that the encoding and decoding of the pictures P21, P24, P12, and P32 to be used as reference pictures are completed and the decoded pictures are stored in decoded-picture buffers before the encoding of the picture P22 is started. Specifically, the pictures in the video sequences M(0), M(1), and M(2) are sequentially encoded in the overall picture encoding order as “P11, P31, P21, P14, P34, P24, P12, P32, P22, P13, P33, P23 . . . ”.

As previously mentioned, the pictures in each of the video sequences M(0), M(1), and M(2) are arranged in the display timing order. The picture encoding section 102 compressively encodes the first-viewpoint video sequence M(0) into the first-viewpoint bitstream S(0) while the timing of the encoding is controlled by the encoding control section 101. The picture encoding section 103 compressively encodes the second-viewpoint video sequence M(1) into the second-viewpoint bitstream S(1) while the timing of the encoding is controlled by the encoding control section 101. The picture encoding section 104 compressively encodes the third-viewpoint video sequence M(2) into the third-viewpoint bitstream S(2) while the timing of the encoding is controlled by the encoding control section 101. The picture encoding sections 102 and 104 generate reference pictures. The picture encoding sections 102 and 104 feed reference pictures to the picture encoding section 103. The encoding by the picture encoding section 103 uses the reference pictures fed from the picture encoding sections 102 and 104.

Preferably, the picture encoding sections 102, 103, and 104 are of the same structure. Accordingly, a picture encoding section used as each of the picture encoding sections 102, 103, and 104 will be described in detail hereafter.

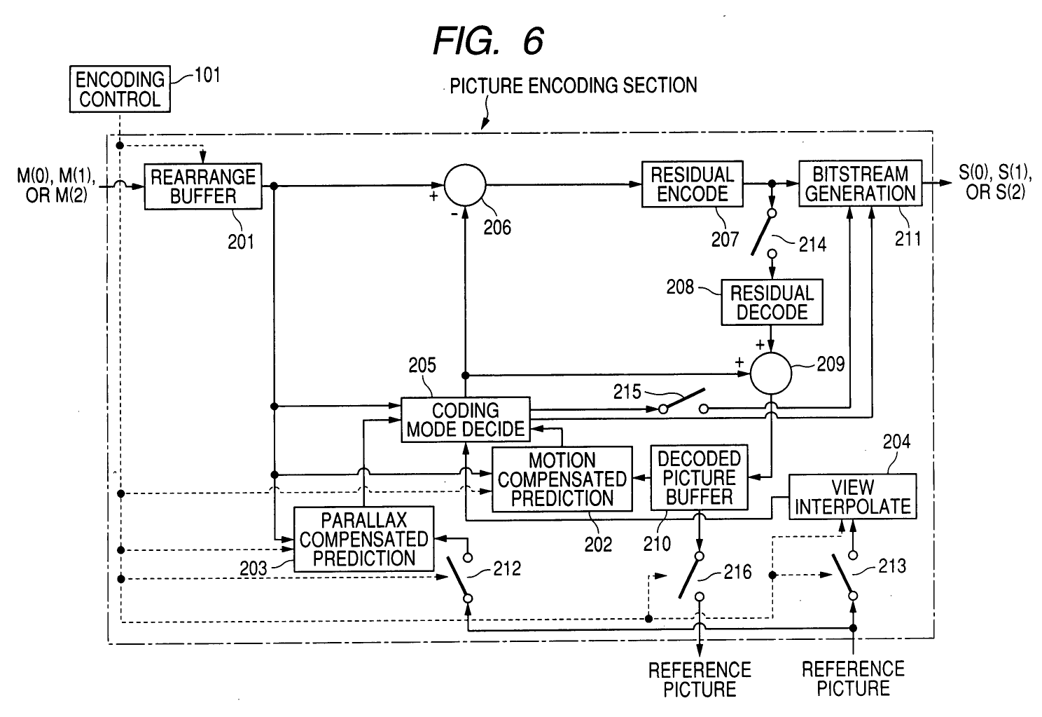

As shown in FIG. 6, a picture encoding section (the picture encoding section 102, 103, or 104) includes a rearranging buffer 201, a motion-compensated predicting section 202, a disparity-compensated predicting section 203, a view interpolating section 204, a coding-mode deciding section 205, a subtracter 206, a residual-signal encoding section 207, a residual-signal decoding section 208, an adder 209, a decoded-picture buffer (a decoded-picture buffer memory) 210, a bitstream generating section 211, and switches 212, 213, 214, 215, and 216. The devices and sections 201-216 are controlled by the encoding control section 101.

In the case where the encoding control section 101 sets the switches 212 and 213 in their OFF states to disable the disparity-compensated predicting section 203 and the view interpolating section 204 while setting the switch 216 in its ON state, the picture encoding section of FIG. 6 operates as the picture encoding section 102 or 104. On the other hand, in the case where the encoding control section 101 sets the switches 212 and 213 in their ON states while setting the switch 216 in its OFF state, the picture encoding section of FIG. 6 operates as the picture encoding section 103.

With reference to FIG. 6, pictures in the video sequence M(0), M(1), or M(2) are sequentially inputted into the rearranging buffer 201 in the display timing order. The rearranging buffer 201 stores the inputted pictures. The rearranging buffer 201 sequentially outputs the stored pictures in the picture encoding order decided by the encoding control section 101. Thus, the rearranging buffer 201 rearranges the pictures from the display timing order to the encoding order. The rearranging buffer 201 divides every picture to be outputted into equal-size blocks each composed of, for example, 16 by 16 pixels. Blocks are also referred to as multi-pixel blocks. The rearranging buffer 201 sequentially outputs blocks (multi-pixel blocks) constituting every picture.

The operation of the picture encoding section of FIG. 6 can be changed among different modes including first, second, third, and fourth modes and other modes having combinations of at least two of the first to fourth modes. During the first mode of operation, a block outputted from the rearranging buffer 201 is subjected to intra coding, and thereby the picture is compressively encoded into a part of the bitstream S(0), S(1), or S(2) without using reference pictures. The used intra coding is known one prescribed by, for example, MPEG-1, MPEG-2, or MPEG-4 AVC/H.264. The intra coding prescribed by MPEG-4 AVC/H.264 is implemented by an intra coding section (not shown). During the second mode of operation, a block outputted from the rearranging buffer 201 is compressively encoded through motion-compensated prediction using a reference picture or pictures resulting from the decoding of an encoded picture or pictures, and motion vectors calculated in the motion-compensated prediction are also encoded. During the third mode of operation, a block outputted from the rearranging buffer 201 is compressively encoded through disparity-compensated prediction using reference pictures originating from the other-viewpoint video sequences, and disparity vectors calculated in the disparity-compensated prediction are also encoded. During the fourth mode of operation, a block outputted from the rearranging buffer 201 is compressively encoded through view interpolation using reference pictures originating from the other-viewpoint video sequences, and disparity vectors are neither encoded nor transmitted. Under the control by the encoding control section 101, the operation of the picture encoding section of FIG. 6 is adaptively changed among the different modes. As previously indicated, the different modes include the first, second, third, and fourth modes, and the other modes having combinations of at least two of the first to fourth modes.

The motion-compensated predicting section 202 sequentially receives blocks (blocks to be encoded) of every picture from the rearranging buffer 201. Basically, the motion-compensated predicting section 202 implements block matching between a current block to be encoded and a reference picture or pictures fed from the decoded-picture buffer 210 in a way conforming to MPEG-2, MPEG-4, or AVC/H.264. During the block matching, the motion-compensated predicting section 202 detects a motion vector or vectors and generates a motion-compensated prediction block (a motion-compensated prediction signal). The motion-compensated predicting section 202 feeds the motion vector or vectors and the motion-compensated prediction signal to the coding-mode deciding section 205.

The encoding control section 101 decides different modes of motion-compensated prediction. Each of the motion-compensated prediction modes is defined by a set of items including an item indicative of whether or not motion-compensated prediction should be performed, an item indicative of the number of a reference picture or pictures, an item indicative of which of decoded pictures should be used as a reference picture or pictures (that is, which of candidate reference pictures should be used as a final reference picture or pictures), and an item indicative of a block size. Each of the items is indicative of a parameter changeable among different states. Thus, each of the items is changeable among different states corresponding to the different states of the related parameter respectively. The motion-compensated prediction modes are assigned to different combinations of the states of the items, respectively. Accordingly, the number of the motion-compensated prediction modes is equal to the number of the different combinations of the states of the items. For example, the block size for motion-compensated prediction can be adaptively changed among predetermined different values (candidate block sizes). Preferably, the greatest of the different values is equal to the size of blocks fed from the rearranging buffer 201. In the case where the current block is composed of 16 by 16 pixels, the different candidate block sizes are, for example, a value of 16 by 16 pixels, a value of 16 by 8 pixels, a value of 8 by 16 pixels, a value of 8 by 8 pixels, a value of 8 by 4 pixels, a value of 4 by 8 pixels, and a value of 4 by 4 pixels.

According to each of the motion-compensated-prediction modes, the encoding control section 101 controls the motion-compensated predicting section 202 to implement corresponding motion-compensated prediction, and to detect a motion vector or vectors and generate a motion-compensated prediction signal. The motion-compensated predicting section 202 feeds the motion vector or vectors and the motion-compensated prediction signal to the coding-mode deciding section 205. The motion-compensated predicting section 202 obtains results (motion vectors and motion-compensated prediction signals) of motion-compensated predictions for the respective motion-compensated-prediction modes. Accordingly, the motion-compensated predicting section 202 feeds the respective-modes motion vectors and the respective-modes motion-compensated prediction signals to the coding-mode deciding section 205.

The motion-compensated prediction section 202 divides one block fed from the rearranging buffer 201 by different values and thereby obtains different-size bocks while being controlled by the encoding control section 101. For example, in the case where one block fed from the rearranging buffer 201 is composed of 16 by 16 pixels, different block sizes are equal to a value of 16 by 16 pixels, a value of 16 by 8 pixels, a value of 8 by 16 pixels, a value of 8 by 8 pixels, a value of 8 by 4 pixels, a value of 4 by 8 pixels, and a value of 4 by 4 pixels. For each of the different block sizes, the motion-compensated predicting section 202 implements motion-compensated prediction on a block-by-block basis. Thus, the motion-compensated predicting section 202 obtains results (motion vectors and motion-compensated prediction signals) of motion-compensated predictions for the respective block sizes.

The disparity-compensated predicting section 203 sequentially receives blocks (blocks to be encoded) of every picture from the rearranging buffer 201. Basically, the disparity-compensated predicting section 203 implements block matching between a current block to be encoded and reference pictures fed from the other picture encoding sections in a way conforming to MPEG-2 Multi-view Profile. During the block matching, the disparity-compensated predicting section 203 detects a disparity vector or vectors and generates a disparity-compensated prediction block (a disparity-compensated prediction signal). The disparity-compensated predicting section 203 feeds the disparity vector or vectors and the disparity-compensated prediction signal to the coding-mode deciding section 205.

The encoding control section 101 decides different modes of disparity-compensated prediction. Each of the disparity-compensated prediction modes is defined by items including an item indicative of whether or not disparity-compensated prediction should be performed, an item indicative of the number of reference pictures, an item indicative of which of decoded pictures should be used as reference pictures (that is, which of candidate reference pictures should be used as final reference pictures), and an item indicative of a block size. Each of the items is indicative of a parameter changeable among different states. Thus, each of the items is changeable among different states corresponding to the different states of the related parameter respectively. The disparity-compensated prediction modes are assigned to different combinations of the states of the items, respectively. Accordingly, the number of the disparity-compensated prediction modes is equal to the number of the different combinations of the states of the items. The block size can be changed among the predetermined different values similarly to the case of the motion-compensated prediction.

In the case where disparity-compensated prediction should be performed, the encoding control section 101 sets the switch 212 in its ON state to feed decoded pictures as reference pictures to the disparity-compensated predicting section 203 from the decoded-picture buffer in the other picture encoding sections.

According to each of the disparity-compensated-prediction modes, the encoding control section 101 controls the disparity-compensated predicting section 203 to implement corresponding disparity-compensated prediction, and to detect a disparity vector or vectors and to generate a disparity-compensated prediction signal. The disparity-compensated predicting section 203 feeds the disparity vector or vectors and the disparity-compensated prediction signal to the coding-mode deciding section 205. The disparity-compensated predicting section 203 obtains results (disparity vectors and disparity-compensated prediction signals) of disparity-compensated predictions for the respective disparity-compensated-prediction modes. Accordingly, the disparity-compensated predicting section 203 feeds the respective-modes disparity vectors and the respective-modes disparity-compensated prediction signals to the coding-mode deciding section 205.

The disparity-compensated prediction section 203 divides one block fed from the rearranging buffer 201 by different values and thereby obtains different-size bocks while being controlled by the encoding control section 101. For each of the different block sizes, the disparity-compensated predicting section 203 implements disparity-compensated prediction on a block-by-block basis. Thus, the disparity-compensated predicting section 203 obtains results (disparity vectors and disparity-compensated prediction signals) of disparity-compensated predictions for the respective block sizes.

The view interpolating section 204 does not refer to a current block to be encoded. The view interpolating section 204 receives two reference pictures from the other picture encoding sections. The view interpolating section 204 implements interpolation responsive to the two reference pictures to generate a view-interpolation block (a view-interpolation signal) corresponding to the current block to be encoded. In the case where there are more than three video sequences relating to multiple viewpoints and more than three picture encoding sections assigned to the respective video sequences, the view interpolating section 204 may receives three or more reference pictures from the other picture encoding sections and implement interpolation responsive to the reference pictures to generate a view-interpolation signal. The view interpolating section 204 feeds the view-interpolation signal to the coding-mode deciding section 205.

The encoding control section 101 decides different modes of view interpolation. Each of the view interpolation modes is defined by items including an item indicative of whether or not view interpolation should be performed, an item indicative of the number of reference pictures, an item indicative of which of decoded pictures should be used as reference pictures (that is, which of candidate reference pictures should be used as final reference pictures), and an item indicative of a block size. Each of the items is indicative of a parameter changeable among different states. Thus, each of the items is changeable among different states corresponding to the different states of the related parameter respectively. The view interpolation modes are assigned to different combinations of the states of the items, respectively. Accordingly, the number of the view interpolation modes is equal to the number of the different combinations of the states of the items. The block size can be changed among the predetermined different values similarly to the case of the motion-compensated prediction.

In the case where view interpolation should be performed, the encoding control section 101 sets the switch 213 in its ON state to feed decoded pictures as reference pictures to the view interpolating section 204 from the decoded-picture buffers in the other picture encoding sections.

According to each of the view interpolation modes, the encoding control section 101 controls the view interpolating section 204 to implement corresponding view interpolation and to generate a view-interpolated signal. The view interpolating section 204 feeds the view-interpolated signal to the coding-mode deciding section 205. The view interpolating section 204 obtains results (view-interpolated signals) of view interpolations for the respective view-interpolation modes. Accordingly, the view interpolating section 204 feeds the respective-modes view-interpolated signals to the coding-mode deciding section 205.

The view interpolating section 204 divides one block by different values and thereby obtains different-size bocks while being controlled by the encoding control section 101. For each of the different block sizes, the view interpolating section 204 implements view interpolation on a block-by-block basis. Thus, the view interpolating section 204 obtains results (view-interpolated signals) of view interpolations for the respective block sizes.

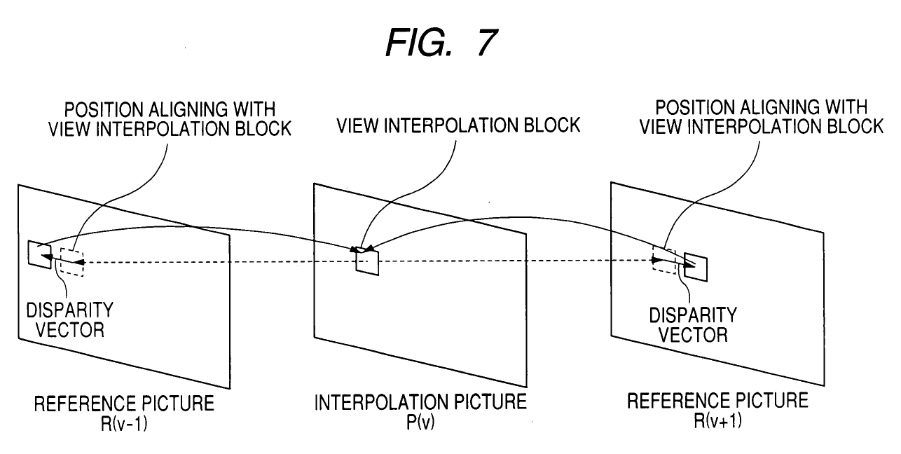

With reference to FIG. 7, the block-matching-based view interpolation performed by the view interpolating section 204 generates an interpolation picture P(v) from reference pictures R(v−1) and R(V+1). Specifically, one is selected among the blocks constituting the reference picture R(v−1). Similarly, one is selected among the blocks constituting the reference picture R(V+1). Block matching is implemented while the selected block in the reference picture R(v−1) and the selected block in the reference picture R(V+1) are sequentially changed from ones to others to be moved in a predetermined range. The selected block in the reference picture R(v−1) and the selected block in the reference picture R(V+1) are moved while they are kept in point symmetry about a center equal to the position of a block to be interpolated. At this time, a movement vector indicating the direction and quantity of the movement of the selected block in the reference picture R(v−1) and a movement vector indicating the direction and quantity of the movement of the selected block in the reference picture R(v+1) are the same in magnitudes of horizontal-direction and vertical-direction components but are opposite in sign. For example, when the selected block in the reference picture R(v−1) is moved by +2 in the horizontal direction, the selected block in the reference picture R(V+1) is moved by −2 in the horizontal direction. For every movement-result positions (every movement vectors), calculation is made as to the sum of the absolute values or the squares of the differences between the pixels constituting the selected block in the reference picture R(v−1) and the pixels constituting the selected block in the reference picture R(V+1). The calculated sum is labeled as an evaluation value. The smallest evaluation value is detected while the selected block in the reference picture R(v−1) and the selected block in the reference picture R(V+1) are sequentially changed from ones to others to be moved in the predetermined range. The selected block in the reference picture R(v−1) and the selected block in the reference picture R(V+1) are identified which have movement vectors corresponding to the smallest evaluation value. For every pair of corresponding pixels in the selected blocks, a weighted mean (a weighted average) of the pixels is calculated. The calculated weighted means are collected to form the interpolation picture (the interpolation block). The degree of the weighting is determined by viewpoint information such as a camera parameter. The weighting is designed so that the reference picture signal relating to the viewpoint closer to the viewpoint of the interpolation picture will be given a greater weight while the reference picture signal relating to the viewpoint remoter from the viewpoint of the interpolation picture will be given a smaller weight. One block may be divided into smaller blocks. In this case, block matching is implemented by a smaller-block by smaller-block basis.

The bitstreams S(0), S(1), and S(2) generated by the encoding apparatus of FIG. 4 are decoded by a multi-view video decoding apparatus. The decoding apparatus implements the same block-matching-based view interpolation as that in the encoding apparatus. Specifically, the block-matching-based view interpolation in the encoding apparatus and that in the decoding apparatus have common actions and parameters including a block matching search range, the degree of the weighting, and the size of a block. Thereby, the encoding apparatus and the decoding apparatus are enabled to obtain equal view-interpolated signals without encoding and decoding disparity vectors.

There are a plurality of candidate coding modes. Each of the candidate coding modes is defined by items including an item indicative of whether or not intra coding should be performed, an item indicative of whether or not motion-compensated prediction should be performed, an item indicative of a type of the motion-compensated prediction to be performed, an item indicative of whether or not disparity-compensated prediction should be performed, an item indicative of a type of the disparity-compensated prediction to be performed, an item indicative of whether or not view interpolation should be performed, an item indicative of a type of the view interpolation to be performed, and an item indicative of a block size. The items defining each of the candidate coding modes include those for the motion-compensated-prediction modes, the disparity-compensated-prediction modes, and the view-interpolation modes. The candidate coding modes include ones indicating respective different combinations of at least two of motion-compensated predictions of plural types, disparity-compensated predictions of plural types, and view interpolations of plural types. The coding-mode deciding section 205 evaluates the candidate coding modes on the basis of the results of the motion-compensated predictions by the motion-compensated predicting section 202, the results of the disparity-compensated predictions by the disparity-compensated predicting section 203, and the results of the view interpolations by the view interpolating section 204. The coding-mode deciding section 205 selects one from the candidate coding modes in accordance with the results of the evaluations. The decided coding mode corresponds to the best evaluation result. The coding-mode deciding section 205 generates a final prediction signal and a final vector or vectors in accordance with the decided coding mode. The final vector or vectors include at least one of a motion vector or vectors and a disparity vector or vectors. The coding-mode deciding section 205 feeds the final prediction signal to the subtracter 206 and the adder 209. The coding-mode deciding section 205 can feed the final vector or vectors to the bitstream generating section 211 via the switch 215.

The coding-mode deciding section 205 makes a decision as to which of intra coding, motion-compensated prediction, disparity-compensated prediction, and view interpolation should be selected and combined, a decision as to which of candidate reference pictures should be used as a final reference picture or pictures, and a decision as to which of the different block sizes should be used in order to realize the most efficient encoding on a block-by-block basis. These decisions are made in stages of the selection of one from the candidate coding modes.

Operation of the coding-mode deciding section 205 will be described below in more detail. Examples of the candidate coding modes are as follows. A first example has a part indicating the use of a combination of motion-compensated prediction from a past reference picture and motion-compensated prediction from a future reference picture. A second example has a part indicating the use of a combination of motion-compensated prediction from a past or future reference picture and disparity-compensated prediction. A third example has a part indicating the use of a combination of motion-compensated prediction from a past or future reference picture and view interpolation.

In the case of a candidate coding mode having a part indicating the use of a combination of motion-compensated prediction from a past reference picture and motion-compensated prediction from a future reference picture for the current block, the motion-compensated prediction from the past reference picture is implemented first to obtain a first motion-compensated prediction block. Subsequently, the motion-compensated prediction from the future reference picture is implemented to obtain a second motion-compensated prediction block. For every pair of corresponding pixels in the first and second motion-compensated prediction blocks, a weighted mean (a weighted average) of the pixels is calculated. The calculated weighted means are collected to form a candidate current block.

In the case of a candidate coding mode having a part indicating the use of a combination of motion-compensated prediction and view interpolation, the motion-compensated prediction is implemented first to obtain a motion-compensated block. Subsequently, the view interpolation is implemented to obtain a view-interpolated block. For every pair of corresponding pixels in the motion-compensated block and the view-interpolated block, a weighted mean (a weighted average) of the pixels is calculated. The calculated weighted means are collected to form a candidate block.

In the case of a candidate coding mode having a part indicating the use of a combination of disparity-compensated prediction and view interpolation, the disparity-compensated prediction is implemented first to obtain a disparity-compensated block. Subsequently, the view interpolation is implemented to obtain a view-interpolated block. For every pair of corresponding pixels in the disparity-compensated block and the view-interpolated block, a weighted mean (a weighted average) of the pixels is calculated. The calculated weighted means are collected to form a candidate block.

In the case of other candidate coding modes having parts indicating the use of combinations of at least two of motion-compensated predictions of plural types, disparity-compensated predictions of plural types, and view interpolations of plural types, candidate blocks are formed in ways similar to the above.

Regarding the calculation of a weighted mean (a weighted average) of the pixels, the weighting is of a 1:1 type, a 1:2 type, or a 1:3 type in weighting ratio.

As previously mentioned, the size of one block is changed among different values. Preferably, the size of one block is in the range of a value of 4 by 4 pixels to a value of 16 by 16 pixels. In general, used prediction/interpolation is adaptively changed on a block-by-block basis.

There are various types of the technique of making a decision on which one of the candidate coding modes is selected as a final coding mode. A preferable example is as follows. For the current block, a encoded data amount (the number of bits for encoding) and a distortion quantity are calculated concerning each of the candidate coding modes. From among the candidate coding modes, one is selected which is optimum in a balance between the calculated coded data amount and the calculated distortion quantity. The decided candidate coding mode is labeled as the final coding mode for the current block. Specifically, concerning each of the candidate coding modes, a prediction signal is calculated from at least one of a motion-compensated prediction signal outputted by the motion-compensated predicting section 202, a disparity-compensated prediction signal outputted by the disparity-compensated predicting section 203, and a view-interpolated signal outputted by the view interpolating section 204 in accordance with the contents of the candidate coding mode for the current block. Concerning each of the candidate coding modes, a residual signal between an original signal and the prediction signal (a motion-compensated signal, a disparity-compensated signal, a view-interpolated signal, and a combined signal, etc.) is calculated for the current block. The original signal is fed from the rearranging buffer 201. Concerning each of the candidate coding modes, the residual signal, vectors (a motion vector or vectors and a disparity vector or vectors), and a signal indicating the candidate coding mode are encoded to generate a bitstream for the current block. The vectors are fed from the motion-compensated predicting section 202 and the disparity-compensated predicting section 203. The bit length of the generated bitstream is calculated for the current block. It should be noted that vectors are absent concerning specified ones of the candidate coding modes which indicate the use of intra coding or view interpolation rather than motion-compensated and disparity-compensated predictions. For each of these specified ones of the candidate coding modes, the residual signal between the original signal and the prediction signal is calculated, and the bit length of the bitstream is calculated which results from encoding only the residual signal and the signal indicating the candidate coding mode for the current block. Concerning each of the candidate coding modes, the calculated bit length is labeled as the coded data amount (the number of bits for encoding) for the current block. Furthermore, the encoded residual signal is decoded, and the decoded residual signal and the prediction signal are added to generate a decoded signal (a decoding-result signal) for the current block. Then, calculation is made as to the sum of the absolute values or the squares of the differences between the pixels constituting the block of the decoded signal and the pixels constituting the block of the original signal. The calculated sum is labeled as the distortion quantity for the current block. The coded data amount is multiplied by a predetermined coefficient, and the multiplication result is added to the distortion quantity. The addition result is labeled as an evaluation value for the current block. In this way, the evaluation values are obtained for the candidate coding modes respectively. The evaluation values are searched for the smallest one. The candidate coding mode which corresponds to the smallest evaluation value is labeled as a final coding mode (a decided coding mode) for the current block. Thus, the coding-mode deciding section 205 obtains the final coding mode for the current block. The coding-mode deciding section 205 feeds a coding-mode signal, that is, a signal representative of the final coding mode (the decided coding mode), to the bitstream generating section 211.

The coding-mode deciding section 205 receives every per-mode motion-compensated prediction block (the per-mode motion-compensated prediction signal) from the motion-compensated predicting section 202. The coding-mode deciding section 205 receives every per-mode disparity-compensated prediction block (the per-mode disparity-compensated prediction signal) from the disparity-compensated predicting section 203. The coding-mode deciding section 205 receives every per-mode view-interpolated block (the per-mode view-interpolated signal) from the view interpolating section 204. The coding-mode deciding section 205 generates a final prediction signal (a final prediction block) from the respective-modes motion-compensated prediction signals, the respective-modes disparity-compensated prediction signals, and the respective-modes view-interpolated signals in accordance with the contents of the final coding mode (the decided coding mode) for the current block. The coding-mode deciding section 205 feeds the final prediction signal to the subtracter 206 and the adder 209.

The coding-mode deciding section 205 receives the per-mode motion vector or vectors from the motion-compensated predicting section 202 for the current block. The coding-mode deciding section 205 receives the per-mode disparity vector or vectors from the disparity-compensated predicting section 203 for the current block. The coding-mode deciding section 205 selects or non-selects one or ones from the respective-modes motion vectors and the respective-modes disparity vectors in accordance with the final coding mode (the decided coding mode) for the current block. The coding-mode deciding section 205 passes the decided vector or vectors (the selected motion vector or vectors and the selected disparity vector or vectors) to the switch 215. The switch 215 can transmit the decided vector or vectors to the bitstream generating section 211.

The subtracter 206 receives a signal from the rearranging buffer 201 which sequentially represents blocks of every picture to be encoded. For the current block, the subtracter 206 subtracts the final prediction signal from the output signal of the rearranging buffer 201 to generate a residual signal (a residual block). The subtracter 206 feeds the residual signal to the residual-signal encoding section 207. For the current block, the residual-signal encoding section 207 encodes the residual signal into an encoded residual signal through signal processing inclusive of orthogonal transform and quantization. The residual-signal encoding section 207 feeds the encoded residual signal to the bitstream generating section 211 and the switch 214.

In the case where a current picture represented by the encoded residual signal should be at least one of a reference picture in motion-compensated prediction for a picture following the current picture in the encoding order, a reference picture in disparity-compensated prediction for a picture relating to another viewpoint, and a reference picture in view interpolation relating to another viewpoint, the switch 214 is set in its ON state by the encoding control section 101 so that the encoded residual signal is passed to the residual-signal decoding section 208. The residual-signal decoding section 208 decodes the encoded residual signal into a decoded residual signal through signal processing inclusive of inverse quantization and inverse orthogonal transform. The decoding by the residual-signal decoding section 208 is inverse with respect to the encoding by the residual-signal encoding section 207. The residual-signal decoding section 208 feeds the decoded residual signal to the adder 209 on a block-by-block basis. The adder 209 receives the final prediction signal from the coding-mode deciding section 205. The adder 209 superimposes the decoded residual signal on the final prediction signal to generate a decoded picture signal. The adder 209 sequentially stores blocks of the decoded picture signal into the decoded-picture buffer 210. The decoded picture signal can be fed from the decoded-picture buffer 210 to the motion-compensated predicting section 202 as a reference picture or pictures for motion-compensated prediction. The switch 216 is connected between the decoded-picture buffer 210 and another picture encoding section. When the switch 216 is set in its ON state by the encoding control section 101, the decoded picture signal can be fed from the decoded-picture buffer 210 to the other picture encoding section as a reference picture for at least one of disparity-compensated prediction and view interpolation implemented in the other picture encoding section.

The bitstream generating section 211 receives the encoded residual signal from the residual-signal encoding section 207. The bitstream generating section 211 receives the coding-mode signal from the coding-mode deciding section 205. Furthermore, the bitstream generating section 211 can receive the motion vector or vectors and the disparity vector or vectors from the coding-mode deciding section 205 via the switch 215. For every block, the bitstream generating section 211 encodes the encoded residual signal, the coding-mode signal, the motion vector or vectors, and the disparity vector or vectors into the bitstream S(0), S(1), or S(2) through entropy encoding inclusive of Huffman encoding or arithmetic encoding. In the case where the encoding of the current block uses motion-compensated prediction or disparity-compensated prediction, the switch 215 is set in its ON position by the encoding control section 101 so that the motion vector or vectors or the disparity vector or vectors are passed to the bitstream generating section 211. Thus, in this case, the bitstream generating section 211 encodes the motion vector or vectors or the disparity vector or vectors to form a part of the bitstream S(0), S(1), or S(2). On the other hand, in the case where the encoding of the current block uses neither motion-compensated prediction nor disparity-compensated prediction, the switch 215 is set in its OFF position by the encoding control section 101 to block the transmission of the motion vector or vectors or the disparity vector or vectors to the bitstream generating section 211. Thus, in this case, the bitstream generating section 211 does not encode the motion vector or vectors or the disparity vector or vectors.

In the picture encoding section of FIG. 6, the elements following the rearranging buffer 201 perform a sequence of the above-mentioned operation steps for each of blocks constituting every picture outputted from the rearranging buffer 201.

With reference back to FIG. 4, the picture encoding sections 102, 103, and 104 feed the bitstreams S(0), S(1), and S(2) to the multiplexing section 105. The multiplexing section 105 multiplexes the bitstreams S(0), S(1), and S(2) into a multiplexed bitstream while being controlled by the encoding control section 101. The multiplexing section 105 outputs the multiplexed bitstream. Generally, it is necessary that the encoding of a picture by referring to a reference picture is performed after the completion of the decoding to obtain the reference picture. Accordingly, the multiplexing by the multiplexing section 105 is accorded with the picture encoding orders used in the picture encoding sections 102, 103, and 104. For example, the multiplexing of the bitstream representing the picture P22 in FIG. 5 is performed after the completion of the multiplexing of the bitstreams representing the pictures P21, P24, P12, and P32. The multiplexing section 105 adds decoding time information and display time information (decoding timing information and display timing information) to the multiplexed bitstream while being controlled by the encoding control section 101. The decoding time information and the display time information enable a decoding side to detect proper decoding timings and proper display timings.

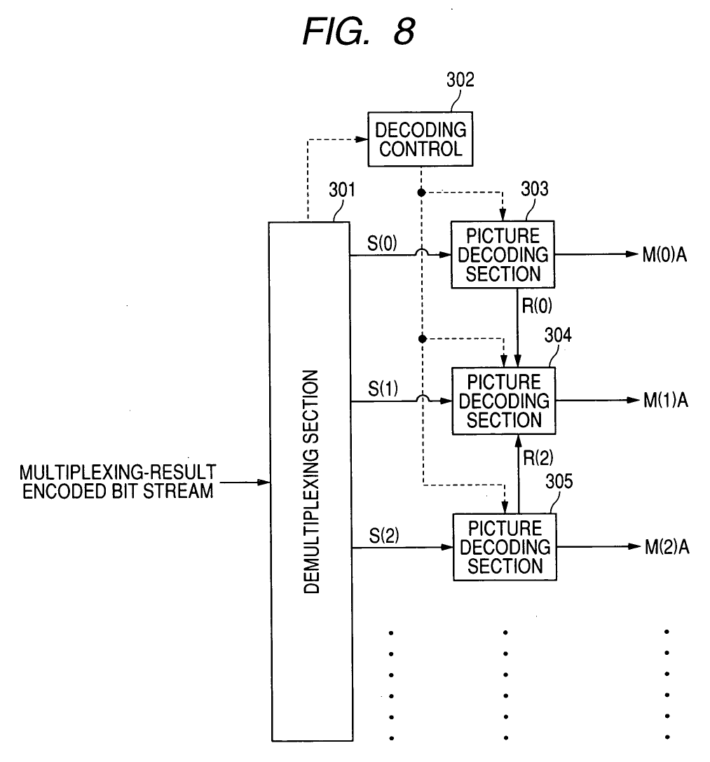

FIG. 8 shows a multi-view video decoding apparatus in the system according to the first embodiment of this invention. The decoding apparatus receives the multiplexed bitstream from the encoding apparatus of FIG. 4. The decoding apparatus decodes the multiplexed bitstream into decoded first-viewpoint, second-viewpoint, and third-viewpoint video sequences M(0)A, M(1)A, and M(3)A.

In the case where the multiplexed bitstream contains more than three view information pieces relating to more than three multiple viewpoints, the decoding apparatus decodes the multiplexed bitstream into video sequences relating to more than three multiple viewpoints.

With reference to FIG. 8, the decoding apparatus includes a demultiplexing section 301, a decoding control section 302, and picture decoding sections 303, 304, and 305.

The demultiplexing section 301 receives the multiplexed bitstream from the encoding apparatus of FIG. 4. The demultiplexing section 301 separates the multiplexed bitstream into the first-viewpoint, second-viewpoint, and third viewpoint bitstreams S(0), S(1), and S(2), and the decoding time information and the display time information (the decoding timing information and the display timing information). The demultiplexing section 301 feeds the bitstreams S(0), S(1), and S(2) to the picture decoding sections 303, 304, and 305, respectively. The demultiplexing section 301 feeds the decoding time information and the display time information to the decoding control section 302.

The decoding control section 302 controls picture decoding orders used in the picture decoding sections 303, 304, and 305 in response to the decoding time information.

The picture decoding section 303 expansively decodes the first-viewpoint bitstream S(0) into the decoded first-viewpoint video sequence M(0)A while the timing of the decoding is controlled by the decoding control section 302. At the same time, the reproduction of the decoded first-viewpoint video sequence M(0)A is controlled by the decoding control section 302 in response to the display time information. The picture decoding section 304 expansively decodes the second-viewpoint bitstream S(1) into the decoded second-viewpoint video sequence M(1)A while the timing of the decoding is controlled by the decoding control section 302. At the same time, the reproduction of the decoded second-viewpoint video sequence M(1)A is controlled by the decoding control section 302 in response to the display time information. The picture decoding section 305 expansively decodes the third-viewpoint bitstream S(2) into the original third-viewpoint video sequence M(2)A while the timing of the decoding is controlled by the decoding control section 302. At the same time, the reproduction of the decoded third-viewpoint video sequence M(2)A is controlled by the decoding control section 302 in response to the display time information. The picture decoding sections 303, 304, and 305 output the decoded video sequences M(0)A, M(1)A, and M(2)A, respectively.

The picture decoding section 304 implements the expansively decoding of the second-viewpoint bitstream S(1) by referring to reference pictures including ones R(0) and R(2) fed from the picture decoding sections 303 and 305.

Preferably, the picture decoding sections 303, 304, and 305 are of the same structure. Accordingly, a picture decoding section used as each of the picture decoding sections 303, 304, and 305 will be described in detail hereafter.

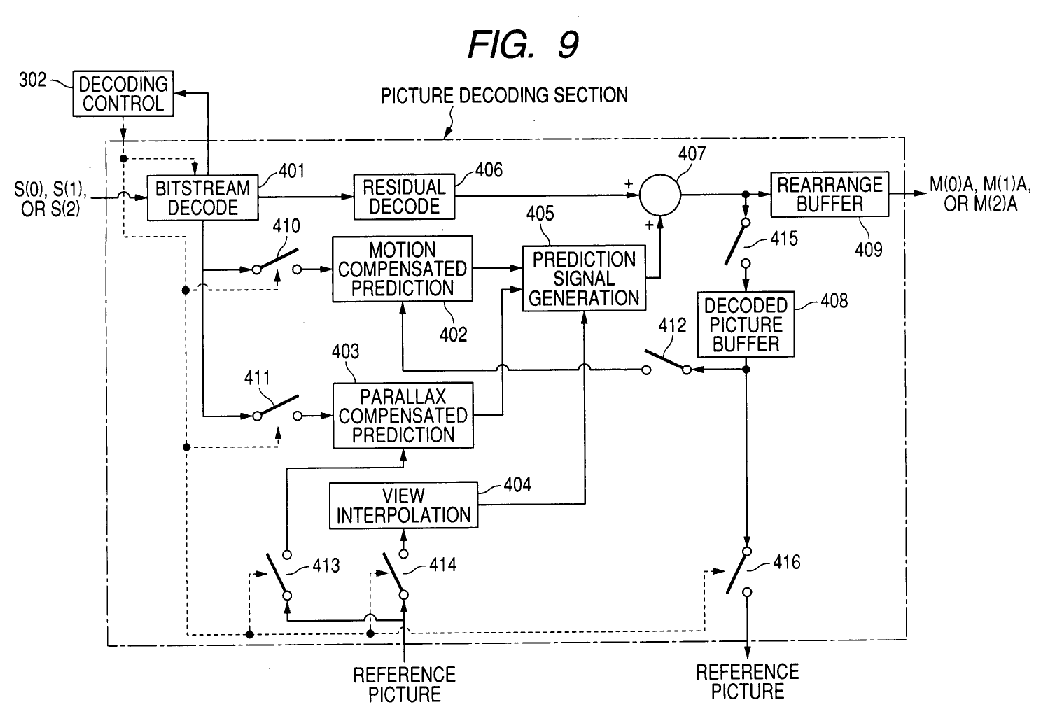

As shown in FIG. 9, a picture decoding section (the picture decoding section 303, 304, or 305) includes a bitstream decoding section 401, a motion-compensated predicting section 402, a disparity-compensated predicting section 403, a view interpolating section 404, a prediction-signal generating section 405, a residual-signal decoding section 406, an adder 407, a decoded-picture buffer (a decoded-picture buffer memory) 408, a rearranging buffer 409, and switches 410, 411, 412, 413, 414, 415, and 416. The devices and sections 401-416 are controlled by the decoding control section 302.

The disparity-compensated predicting section 403 is connected to the other picture decoding sections via the switch 413. Thus, the disparity-compensated predicting section 403 can receive reference pictures from the other picture decoding sections. The view interpolating section 404 is connected to the other picture decoding sections via the switch 414. Thus, the view interpolating section 404 can receive reference pictures from the other picture decoding sections.

The switch 416 is connected between the decoded-picture buffer 408 and another picture decoding section. When the switch 416 is set in its ON state, a decoded picture signal can be fed from the decoded-picture buffer 408 to the other picture decoding section as a reference picture for at least one of disparity-compensated prediction and view interpolation implemented in the other picture decoding section.

In the case where the decoding control section 302 sets the switches 413 and 414 in their OFF states to disable the disparity-compensated predicting section 403 and the view interpolating section 404 while setting the switch 416 in its ON state, the picture decoding section of FIG. 9 operates as the picture decoding section 303 or 305. On the other hand, in the case where the decoding control section 302 sets the switches 413 and 414 in their ON states while setting the switch 416 in its OFF state, the picture decoding section of FIG. 9 operates as the picture decoding section 304.

With reference to FIG. 9, the bitstream decoding section 401 receives the bitstream S(0), S(1), or S(2). The bitstream decoding section 401 decodes the bitstream S(0), S(1), or S(2) into a coding-mode signal, a motion vector or vectors, a disparity vector or vectors, and an encoded residual signal on a block-by-block basis. The operation of the bitstream decoding section 401 is inverse with respect to the operation of the bitstream generating section 211 in FIG. 6. The bitstream decoding section 401 feeds the coding-mode signal to the decoding control section 302. The bitstream decoding section 401 feeds the motion vector or vectors to the switch 410. The bitstream decoding section 401 feeds the disparity vector or vectors to the switch 411. The bitstream decoding section 401 feeds the encoded residual signal to the residual-signal decoding section 406.

The decoding control section 302 detects, from the coding-mode signal, a mode of the encoding of an original block corresponding to every block handled by the bitstream decoding section 401. The detected coding mode describes a set of items including an item indicating which one or ones of motion-compensated prediction, disparity-compensated prediction, and view interpolation have been used in the encoding of the original block, an item indicating which one or ones of pictures have been used as a reference picture or pictures in the encoding of the original block, and an item indicating the size of a block divided from the original block. The decoding control section 302 controls the devices and sections 401-416 in accordance with the detected coding mode.

In the case where the detected coding mode indicates that the original block corresponding to the current block handled by the picture decoding section has been subjected to motion-compensated prediction, the decoding control section 302 sets the switch 410 in its ON position so that the switch 410 passes the motion vector or vectors to the motion-compensated predicting section 402. The motion-compensated predicting section 402 implements motion-compensated prediction from a reference picture or pictures in response to the motion vector or vectors, and thereby generates a motion-compensated prediction block (a motion-compensated prediction signal). In this case, the reference picture or pictures are fed from the decoded-picture buffer 408 via the switch 412. The motion-compensated predicting section 402 feeds the motion-compensated prediction block to the prediction-signal generating section 405.

In the case where the detected coding mode indicates that the original block corresponding to the current block handled by the picture decoding section has been subjected to disparity-compensated prediction, the decoding control section 302 sets the switch 411 in its ON position so that the switch 411 passes the disparity vector or vectors to the disparity-compensated predicting section 403. The disparity-compensated predicting section 403 implements disparity-compensated prediction from reference pictures in response to the disparity vector or vectors, and thereby generates a disparity-compensated prediction block (a disparity-compensated prediction signal). In this case, the reference pictures are fed from the decoded-picture buffers in the other picture decoding sections via the switch 413. The disparity-compensated predicting section 403 feeds the disparity-compensated prediction block to the prediction-signal generating section 405.

In the case where the detected coding mode indicates that the original block corresponding to the current block handled by the picture decoding section has been subjected to view interpolation, the decoding control section 302 sets the switch 414 in its ON position so that the switch 414 transmits reference pictures to the view interpolating section 404 from the decoded-picture buffers in the other picture decoding sections. The view interpolating section 404 implements view interpolation in response to the reference pictures, and thereby generates a view-interpolated block (a view-interpolated signal). The view interpolating section 404 feeds the view-interpolated block to the prediction-signal generating section 405.

The view interpolation by the view interpolating section 404 is the same as that in the encoding apparatus. Accordingly, the view-interpolated block generated by the view interpolating section 404 is the same as that generated in the encoding apparatus.

For the current block, the prediction-signal generating section 405 generates a final prediction signal from at least one of the motion-compensated prediction block, the disparity-compensated prediction block, and the view-interpolated block while being controlled by the decoding control section 302 in accordance with the detected coding mode. The prediction-signal generating section 405 feeds the final prediction signal to the adder 407.

The residual-signal decoding section 406 decodes the encoded residual signal into a decoded residual signal through signal processing inclusive of inverse quantization and inverse orthogonal transform. The residual-signal decoding section 406 feeds the decoded residual signal to the adder 407 on a block-by-block basis. The adder 407 superimposes the decoded residual signal on the final prediction signal to generate a decoded picture signal. The adder 407 sequentially stores blocks of the decoded picture signal into the rearranging buffer 409. At the same time, the adder 407 feeds the decoded picture signal to the switch 415.

In the case where the current picture represented by the decoded picture signal should be used as a reference picture in at least one of motion-compensated prediction, other-viewpoint disparity-compensated prediction, and view interpolation for the decoding of an encoded picture later in decoding timing than the current picture, the switch 415 is set in its ON position by the decoding control section 302 so that blocks of the decoded picture signal are sequentially stored into the decoded-picture buffer 408. Here, the rearranging buffer 409 and the decoded-picture buffer 408 can be a common storage area.

When the switch 412 is set in its ON state by the decoding control section 302, the decoded picture signal can be fed from the decoded-picture buffer 408 to the motion-compensated predicting section 402 as a reference picture or pictures for motion-compensated prediction. When the switch 416 is set in its ON state by the decoding control section 302, the decoded picture signal can be fed from the decoded-picture buffer 408 to the other picture encoding section as a reference picture for at least one of disparity-compensated prediction and view interpolation implemented in the other picture encoding section.

In the picture decoding section of FIG. 9, the bitstream decoding section 401 and the subsequent elements perform a sequence of the above-mentioned operation steps for each of blocks constituting every picture represented by the bitstream S(0), S(1), or S(2).

The rearranging buffer 409 rearranges picture-corresponding segments (pictures) of the decoded picture signal from the picture decoding order to the display timing order while being controlled by the decoding control section 302 in response to the display time information. The rearranging buffer 409 sequentially outputs picture-corresponding segments of the decoded picture signal in the display timing order.

As previously mentioned, regarding the picture encoding section in FIG. 6, there are an operation mode in which a motion vector or vectors and residual components are encoded through motion-compensated prediction utilizing a temporal redundancy, and an operation mode in which a disparity vector or vectors and residual components are encoded through disparity-compensated prediction utilizing an inter-view redundancy. The picture encoding section adaptively selects and non-selects these operation modes on a block-by-block basis. Thus, for a portion of a video sequence which represents still pictures and has a high temporal correlation, the encoding is performed through motion-compensated prediction. For portions of video sequences which have small inter-view differences, the encoding is performed through disparity-compensated prediction. Thereby, a high coding efficiency is attained.

As previously mentioned, a picture relating to a viewpoint of interest can be encoded through view interpolation in which decoded pictures relating to other viewpoints are used as reference pictures and a prediction signal (a view-interpolated signal) is generated from the reference pictures. Viewpoint interpolation does not require the encoding of a motion vector or vectors and a disparity vector or vectors. Regarding the picture encoding section in FIG. 6, there is an operation mode in which view interpolation is performed. The picture encoding section adaptively selects and non-selects this operation mode on a block-by-block basis. For a multi-picture block having high correlations with other-viewpoint ones, this operation mode is selected. Thereby, a higher coding efficiency is attained.

The picture decoding section in FIG. 9 can precisely decode the bitstream S(0), S(1), or S(2) which results from the above-mentioned highly-efficient coding.

### Second Embodiment

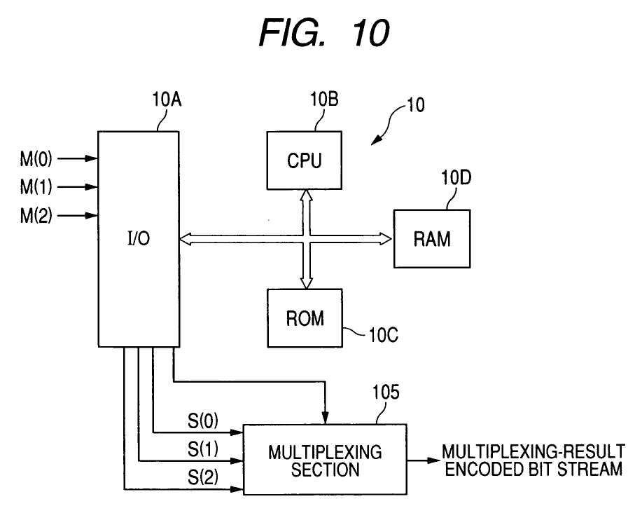

FIG. 10 shows a multi-view video encoding apparatus in a system according to a second embodiment of this invention. The encoding apparatus of FIG. 10 is similar to that of FIG. 4 except for design changes mentioned hereafter.

The encoding apparatus of FIG. 10 includes a computer system 10 having a combination of an input/output port 10A, a CPU 10B, a ROM 10C, and a RAM 10D. The encoding apparatus further includes the multiplexing section 105. The input/output port 10A in the computer system 10 receives the video sequences M(0), M(1), and M(2). The computer system 10 processes the video sequences M(0), M(1), and M(2) into the bitstreams S(0), S(1), and S(2) respectively. The input/output port 10A outputs the bitstreams S(0), S(1), and S(2) to the multiplexing section 105.

The multiplexing section 105 multiplexes the bitstreams S(0), S(1), and S(2), the decoding time information (the decoding timing information), and the display time information (the display timing information) into the multiplexed bitstream while being controlled by the computer system 10. The multiplexing section 105 outputs the multiplexed bitstream.

The computer system 10 operates in accordance with a control program (a computer program) stored in the ROM 10C or the RAM 10D.

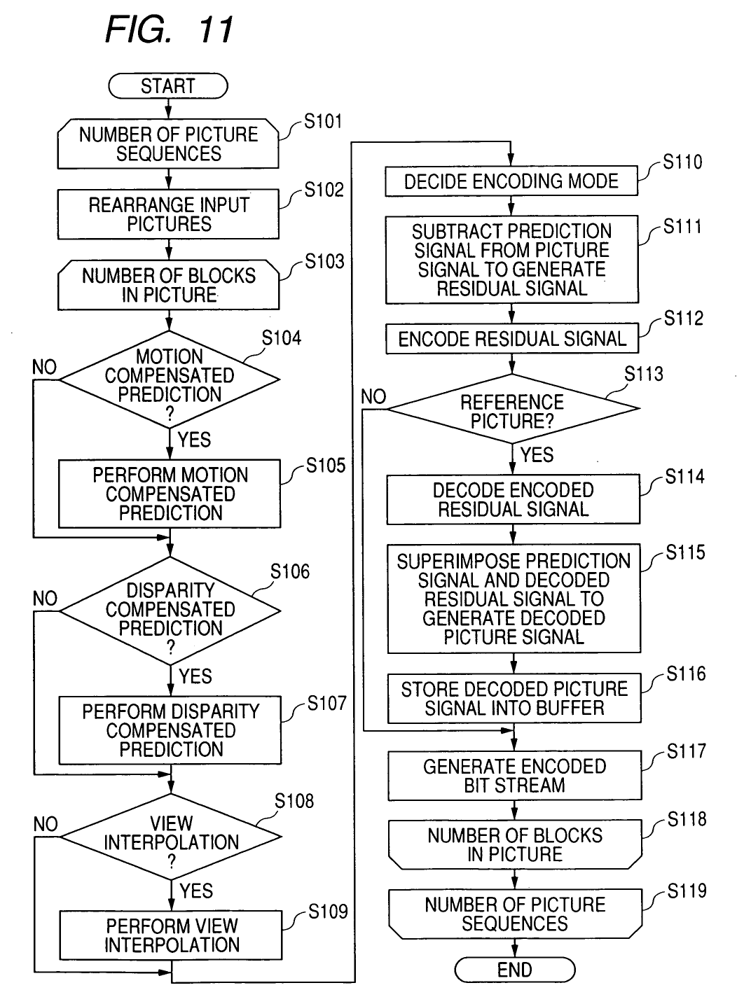

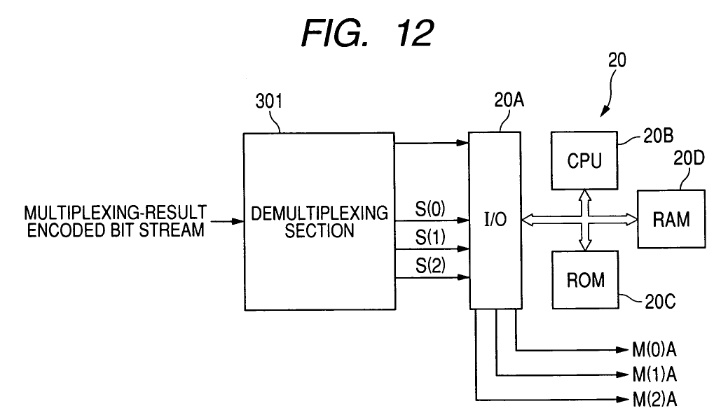

FIG. 11 is a flowchart of a segment of the control program. In FIG. 11, loop points S101 and S119 indicate that a sequence of steps between them should be executed for each of the video sequences M(0), M(1), and M(2). Furthermore, loop points S103 and S118 indicate that a sequence of steps between them should be executed for each of blocks constituting every picture of interest.

As shown in FIG. 11, the program reaches a step S102 through the loop point S101 after the start of the program segment. The step S102 rearranges pictures in the video sequence M(0), M(1), or M(2) from the display timing order to the picture encoding order. Then, the program advances from the step S102 to a step S104 through the loop point S103. The step S102 corresponds to the rearranging buffer 201 in FIG. 6.

The step S104 decides whether or not motion-compensated prediction should be performed for the current block. When the motion-compensated prediction should be performed, the program advances from the step S104 to a step S105. Otherwise, the program jumps from the step S104 to a step S106.

The step S105 performs the motion-compensated prediction in each of the different modes for the current block. Accordingly, the step S105 detects a motion vector or vectors and generates a motion-compensated prediction block (a motion-compensated prediction signal) corresponding to the current block for each of the motion-compensated prediction modes. The step S105 implements the above actions for each of the different block sizes. After the step S105, the program advances to the step S106. The step S105 corresponds to the motion-compensated predicting section 202 in FIG. 6.

The step S106 decides whether or not disparity-compensated prediction should be performed for the current block. When the disparity-compensated prediction should be performed, the program advances from the step S106 to a step S107. Otherwise, the program jumps from the step S106 to a step S108.

The step S107 performs the disparity-compensated prediction in each of the different modes for the current block. Accordingly, the step S107 detects a disparity vector or vectors and generates a disparity-compensated prediction block (a disparity-compensated prediction signal) corresponding to the current block for each of the disparity-compensated prediction modes. The step S107 implements the above actions for each of the different block sizes. After the step S107, the program advances to the step S108. The step S107 corresponds to the disparity-compensated predicting section 203 in FIG. 6.

The step S108 decides whether or not view interpolation should be performed for the current block. When the view interpolation should be performed, the program advances from the step S108 to a step S109. Otherwise, the program jumps from the step S108 to a step S110.

The step S109 performs the view interpolation in each of the different modes for the current block. Accordingly, the step S109 generates a view-interpolated block (a view-interpolated signal) corresponding to the current block for each of the view interpolation modes. The step S109 implements the above action for each of the different block sizes. After the step S109, the program advances to the step S110. The step S109 corresponds to the view interpolating section 204 in FIG. 6.

The step S110 decides a coding mode on the basis of the results of the decisions at the steps S104, S106, and S108, and the signals generated by the steps S105, S107, and S109. The step S110 generates a final prediction signal (a final prediction block) from one of the motion-compensated prediction signals, one of the disparity-compensated prediction signals, and one of the view-interpolated signals according to the decided coding mode for the current block. The step S110 corresponds to the coding-mode deciding section 205 in FIG. 6.

A step S111 following the step S110 subtracts the final prediction signal from the current-block picture signal to generate the residual signal. The step S111 corresponds to the subtracter 206 in FIG. 6.

A step S112 subsequent to the step S111 encodes the residual signal into an encoded residual signal through the signal processing inclusive of the orthogonal transform and the quantization for the current block. The step S112 corresponds to the residual-signal encoding section 207 in FIG. 6.

A step S113 following the step S112 decides whether or not the current picture represented by the encoded residual signal should be at least one of a reference picture in motion-compensated prediction for a picture following the current picture in the encoding order, a reference picture in disparity-compensated prediction for a picture relating to another viewpoint, and a reference picture in view interpolation relating to another viewpoint. When the current picture should be at least one of the reference pictures, the program advances from the step S113 to a step S114. Otherwise, the program jumps from the step S113 to a step S117.

The step S114 decodes the encoded residual signal into the decoded residual signal through the signal processing inclusive of the inverse quantization and the inverse orthogonal transform. The step S114 corresponds to the residual-signal decoding section 208 in FIG. 6.

A step S115 following the step S114 superimposes the decoded residual signal on the final prediction signal to generate the decoded picture signal. The step S115 corresponds to the adder 209 in FIG. 6.

A step S116 subsequent to the step S114 stores the decoded picture signal into the RAM 10D. The decoded picture signal in the RAM 10D can be used as a reference picture or pictures for motion-compensated prediction. In addition, the decoded picture signal can be used as a reference picture for at least one of disparity-compensated prediction and view interpolation implemented regarding another viewpoint. After the step S116, the program advances to the step S117.

For the current block, the step S117 encodes the encoded residual signal, the signal representative of the decided coding mode, the motion vector or vectors, and the disparity vector or vectors into the bitstream S(0), S(1), or S(2) through the entropy encoding inclusive of the Huffman encoding or the arithmetic encoding. Then, the program exits from the step S117 and passes through the loop points S118 and S119 before the current execution cycle of the program segment ends. The step S117 corresponds to the bitstream generating section 211 in FIG. 6.

FIG. 12 shows a multi-view video decoding apparatus in the system according to the second embodiment of this invention. The decoding apparatus of FIG. 12 is similar to that of FIG. 8 except for design changes mentioned hereafter.

The decoding apparatus of FIG. 12 includes the demultiplexing section 301 and a computer system 20 having a combination of an input/output port 20A, a CPU 20B, a ROM 20C, and a RAM 20D. The input/output port 20A receives the bitstreams S(0), S(1), and S(2), the encoding time information, and the display time information from the demultiplexing section 301. The computer system 20 decodes the bitstreams S(0), S(1), and S(2) into the decoded video sequences M(0)A, M(1)A, and M(3)A in response to the encoding time information and the display time information. The input/output port 20A outputs the decoded video sequences M(0)A, M(1)A, and M(3)A.

The computer system 20 operates in accordance with a control program (a computer program) stored in the ROM 20C or the RAM 20D.

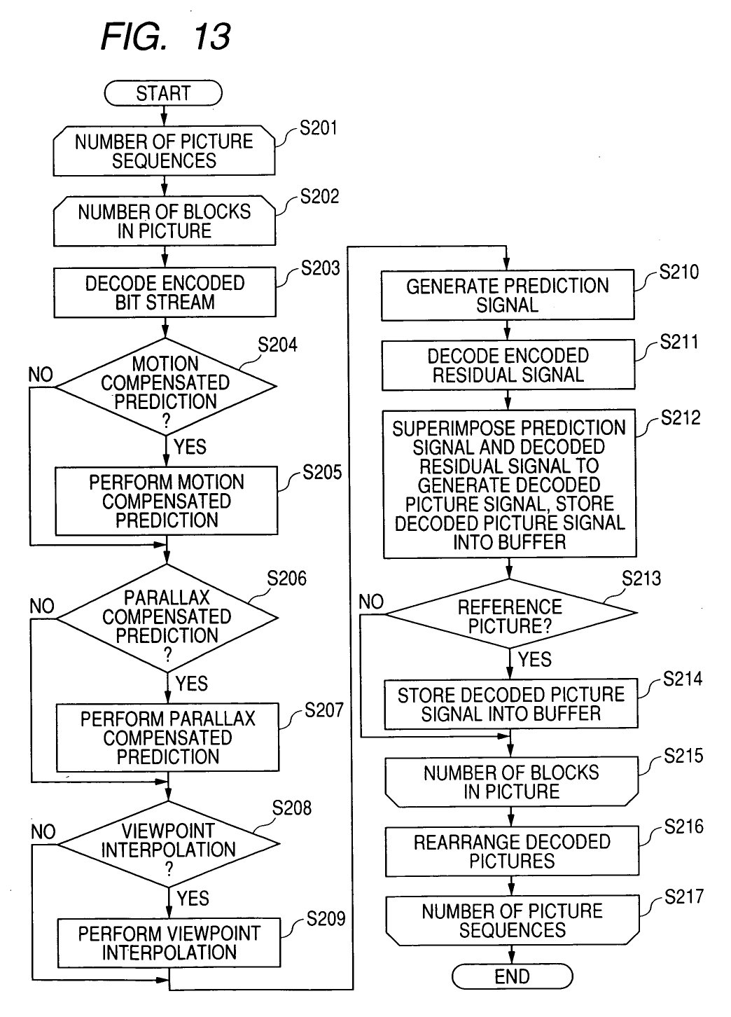

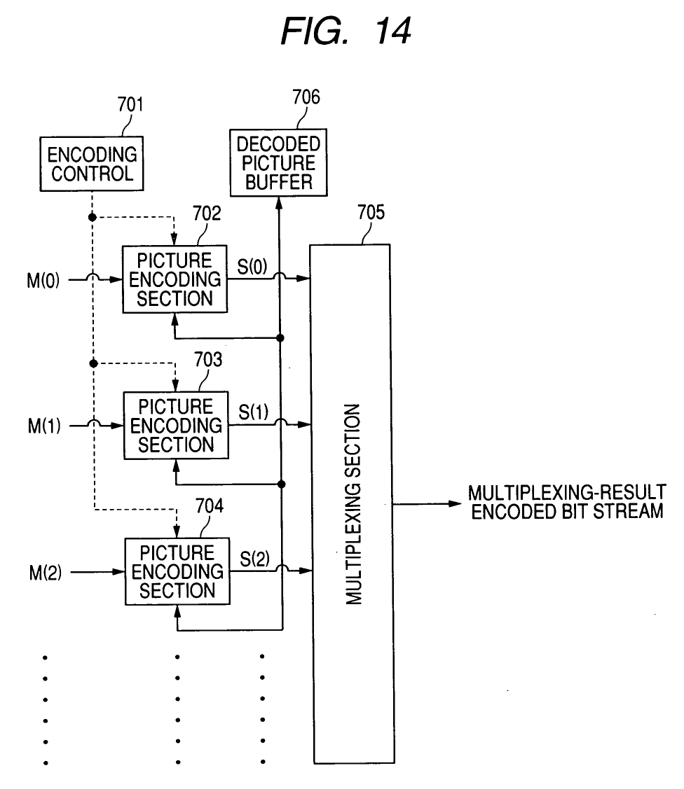

FIG. 13 is a flowchart of a segment of the control program. In FIG. 13, loop points S201 and S217 indicate that a sequence of steps between them should be executed for each of the bitstreams S(0), S(1), and S(2).

Furthermore, loop points S202 and S215 indicate that a sequence of steps between them should be executed for each of blocks constituting every picture of interest. As shown in FIG. 13, the program reaches a step S203 through the loop points S201 and S202 after the start of the program segment. For the current block, the step S203 decodes the bitstream S(0), S(1), or S(2) into the coding-mode signal, the motion vector or vectors, the disparity vector or vectors, and the encoded residual signal. The step S203 corresponds to the bitstream decoding section 401 in FIG. 9.

A step S204 following the step S203 decides whether or not the motion-compensated prediction should be performed on the basis of the contents of the coding-mode signal. When the motion-compensated prediction should be performed, the program advances from the step S204 to a step S205. Otherwise, the program jumps from the step S204 to a step S206.

The step S205 performs the motion-compensated prediction from a reference picture or pictures in response to the motion vector or vectors, and thereby generates the motion-compensated prediction block (the motion-compensated prediction signal). After the step S205, the program advances to the step S206. The step S205 corresponds to the motion-compensated predicting section 402 in FIG. 9.

The step S206 decides whether or not the disparity-compensated prediction should be performed on the basis of the contents of the coding-mode signal. When the disparity-compensated prediction should be performed, the program advances from the step S206 to a step S207. Otherwise, the program jumps from the step S206 to a step S208.

The step S207 performs the disparity-compensated prediction from other-viewpoint reference pictures in response to the disparity vector or vectors, and thereby generates the disparity-compensated prediction block (the disparity-compensated prediction signal). After the step S207, the program advances to the step S208. The step S207 corresponds to the disparity-compensated predicting section 403 in FIG. 9.

The step S208 decides whether or not the view interpolation should be performed on the basis of the contents of the coding-mode signal. When the view interpolation should be performed, the program advances from the step S208 to a step S209. Otherwise, the program jumps from the step S208 to a step S210.

The step S209 performs the view interpolation in response to other-viewpoint reference pictures, and thereby generates the view-interpolated block (the view-interpolated signal). After the step S209, the program advances to the step S210. The step S209 corresponds to the view interpolating section 404 in FIG. 9.

For the current block, the step S210 generates the final prediction signal from at least one of the motion-compensated prediction block, the disparity-compensated prediction block, and the view-interpolated block in accordance with the contents of the coding-mode signal. The step S210 corresponds to the prediction-signal generating section 405 in FIG. 9.

A step S211 following the step S210 decodes the encoded residual signal into the decoded residual signal through the signal processing inclusive of the inverse quantization and the inverse orthogonal transform. The step S211 corresponds to the residual-signal decoding section 406 in FIG. 9.

A step S212 subsequent to the step S211 superimposes the decoded residual signal on the final prediction signal to generate a decoded picture signal. The step S212 stores the decoded picture signal into the RAM 20D. The step S212 corresponds to the adder 407 in FIG. 9.

A step S213 following the step S212 decides whether or not the current picture represented by the decoded picture signal should be used as a reference picture in at least one of motion-compensated prediction, other-viewpoint disparity-compensated prediction, and view interpolation for the decoding of an encoded picture later in decoding timing than the current picture. When the current picture should be used as a reference picture, the program advances from the step S213 to a step S214. Otherwise, the program jumps from the step S213 to a step S203 through the loop points S215 and S202, or a step S216 through the loop point S215.

The step S214 stores the decoded picture signal into the RAM 20D. Here, the rearranging buffer 409 and the decoded-picture buffer 408 can be a common storage area. In this case, the step S214 can be left out. The decoded picture signal in the RAM 20D can be used as a reference picture in at least one of motion-compensated prediction, other-viewpoint disparity-compensated prediction, and view interpolation for the decoding of an encoded picture later in decoding timing than the current picture. After the step S214, the program advances to the step S203 through the loop points S215 and S202, or the step S216 through the loop point S215.

The step S216 rearranges picture-corresponding segments (pictures) of the decoded picture signal in the RAM 20D from the picture decoding order to the display timing order. Then, the program exits from the step S216 and passes through the loop point S217 before the current execution cycle of the program segment ends. The step S216 corresponds to the rearranging buffer 409 in FIG. 9.

### Third Embodiment

FIG. 14 shows a multi-view video encoding apparatus in a system according to a third embodiment of this invention. The encoding apparatus of FIG. 14 is similar to that of FIG. 4 except for design changes mentioned hereafter.

The encoding apparatus of FIG. 14 includes an encoding control section 701, picture encoding sections 702, 703, and 704, and a multiplexing section 705 which are basically similar to the encoding control section 101, the picture encoding sections 102, 103, and 104, and the multiplexing section 105 in FIG. 4. The encoding apparatus further includes a decoded-picture buffer (a decoded-picture buffer memory) 706 located outside the picture encoding sections 702, 703, and 704. The decoded-picture buffer 706 is used as a decoded-picture buffer 210 (see FIG. 6) in each of the picture encoding sections 102, 103, and 104. Accordingly, each of the picture encoding sections 702, 703, and 704 does not contain a decoded-picture buffer.

Decoded pictures generated by the picture encoding sections 702, 703, and 704 are stored into the decoded-picture buffer 706, and are read out therefrom as reference pictures.

### Fourth Embodiment

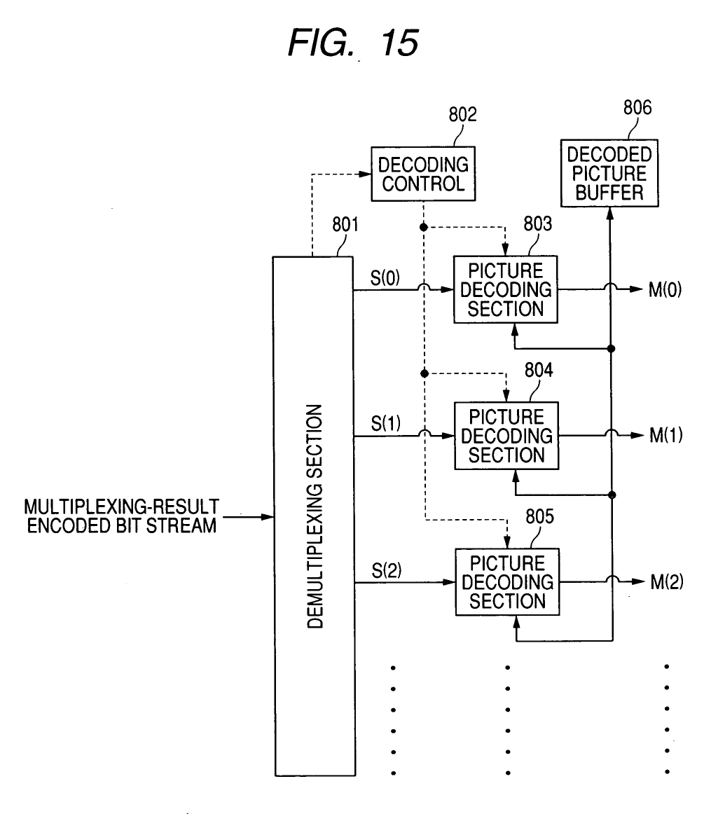

FIG. 15 shows a multi-view video decoding apparatus in a system according to a fourth embodiment of this invention. The decoding apparatus of FIG. 15 is similar to that of FIG. 8 except for design changes mentioned hereafter.

The decoding apparatus of FIG. 15 includes a demultiplexing section 801, a decoding control section 802, and picture decoding sections 803, 804, and 805 which are basically similar to the demultiplexing section 301, the decoding control section 302, and the picture decoding sections 303, 304, and 305 in FIG. 8. The decoding apparatus further includes a decoded-picture buffer (a decoded-picture buffer memory) 806 located outside the picture decoding sections 803, 804, and 805. The decoded-picture buffer 806 is used as a decoded-picture buffer 408 (see FIG. 9) in each of the picture decoding sections 303, 304, and 305. Accordingly, each of the picture decoding sections 803, 804, and 805 does not contain a decoded-picture buffer.

Decoded pictures generated by the picture decoding sections 803, 804, and 805 are stored into the decoded-picture buffer 806, and are read out therefrom as reference pictures.

### Fifth Embodiment

A fifth embodiment of this invention is similar to the first or second embodiment thereof except for design changes mentioned hereafter. The fifth embodiment of this invention is designed to handle still pictures taken from multiple viewpoints rather than moving pictures. The fifth embodiment of this invention does not implement motion-compensated prediction.

### Sixth Embodiment

A sixth embodiment of this invention is similar to the first or second embodiment thereof except for design changes mentioned hereafter. The sixth embodiment of this invention replaces the block-matching-based view interpolation by known other-type view interpolation.

According to an example of the known other-type view interpolation, an epipolar plane image (EPI) is generated from multi-view video, and interpolation steps are taken to generate data representing regions between lines on the EPI.

### Seventh Embodiment

A seventh embodiment of this invention is similar to the first or second embodiment thereof except for design changes mentioned hereafter. According to the seventh embodiment of this invention, interpolations of plural different types are defined. One is selected from the interpolations of the different types in accordance with a flag on a picture-by-picture basis or an area-by-area basis, where every area is formed by a group of multi-pixel blocks. The selected interpolation is implemented.

### Eighth Embodiment

An eighth embodiment of this invention is similar to the first or second embodiment thereof except for design changes mentioned hereafter. According to the eighth embodiment of this invention, one is selected as a candidate from the disparity-compensated prediction and the view interpolation on a picture-by-picture basis or an area-by-area basis where every area is formed by a group of multi-pixel blocks. A flag is generated which indicates the selected prediction or interpolation corresponding to the candidate. The flag forms a part of the coding-mode signal. The flag is encoded. It is possible to reduce the amount of data resulting from the encoding of the coding-mode signal.

### Ninth Embodiment

A ninth embodiment of this invention is similar to the first or second embodiment thereof except for design changes mentioned hereafter. In the ninth embodiment of this invention, the bitstreams S(0), S(1), and S(2) are independently transmitted from the encoding apparatus to the decoding apparatus without being multiplexed. Alternatively, the bitstreams S(0), S(1), and S(2) may be independently stored into a storage unit or a recording medium without being multiplexed. The decoding apparatus receives the bitstreams S(0), S(1), and S(2) independently before decoding them.

### Tenth Embodiment

A tenth embodiment of this invention is similar to the first or second embodiment thereof except for design changes mentioned hereafter. The tenth embodiment of this invention relates to one of a transmission system, a storage system, a receiving system which implement the encoding and decoding of multi-view video.

### Eleventh Embodiment

An eleventh embodiment of this invention is similar to the second embodiment thereof except for design changes mentioned hereafter. According to the eleventh embodiment of this invention, the computer programs (the control programs for the computer systems 10 and 20) are originally stored in a computer-readable recording medium or mediums. The computer programs are installed on the computer systems 10 and 20 from the recording medium or mediums.

Alternatively, the computer programs may be downloaded into the computer systems 10 and 20 from a server through a wire or wireless communication network. The computer programs may be provided as data transmitted by digital terrestrial broadcasting or digital satellite broadcasting.

What is claimed is:

1. An apparatus for encoding pictures taken from multiple viewpoints, comprising:
first means for encoding a picture taken from a first viewpoint;
second means provided in the first means for generating a first decoded picture in the encoding by the first means;
third means for encoding a picture taken from a second viewpoint different from the first viewpoint;
fourth means provided in the third means for generating a second decoded picture in the encoding by the third means;
fifth means for performing view interpolation responsive to the first decoded picture generated by the second means and the second decoded picture generated by the fourth means to generate a view-interpolated signal for every multi-pixel block;
sixth means for deciding one from different coding modes including coding modes relating to the view interpolation performed by the fifth means for every multi-pixel block;
seventh means for generating a prediction signal in accordance with the coding mode decided by the sixth means for every multi-pixel block;
eighth means for subtracting the prediction signal generated by the seventh means from a picture taken from a third viewpoint to generate a residual signal for every multi-pixel block, the third viewpoint being different from the first and second viewpoints; and
ninth means for encoding a signal representative of the coding mode decided by the sixth means and the residual signal generated by eighth means to generate encoded data representing the picture taken from the third viewpoint and containing the signal representative of the decided coding mode.

2. A method of encoding pictures taken from multiple viewpoints, comprising the steps of:
encoding a picture taken from a first viewpoint;
generating a first decoded picture in the encoding of the picture taken from the first viewpoint;
encoding a picture taken from a second viewpoint different from the first viewpoint;
generating a second decoded picture in the encoding of the picture taken from the second viewpoint;
performing view interpolation responsive to the first decoded picture and the second decoded picture to generate a view-interpolated signal for every multi-pixel block;
deciding one from different coding modes including coding modes relating to the view interpolation for every multi-pixel block;
generating a prediction signal in accordance with the decided coding mode for every multi-pixel block;
subtracting the prediction signal from a picture taken from a third viewpoint to generate a residual signal for every multi-pixel block, the third viewpoint being different from the first and second viewpoints; and
encoding a signal representative of the decided coding mode and the residual signal to generate encoded data representing the picture taken from the third viewpoint and containing the signal representative of the decided coding mode.

3. A computer program in a computer readable medium, comprising the steps of:
encoding a picture taken from a first viewpoint;
generating a first decoded picture in the encoding of the picture taken from the first viewpoint;
encoding a picture taken from a second viewpoint different from the first viewpoint;
generating a second decoded picture in the encoding of the picture taken from the second viewpoint;
performing view interpolation responsive to the first decoded picture and the second decoded picture to generate a view-interpolated signal for every multi-pixel block;
deciding one from different coding modes including coding modes relating to the view interpolation for every multi-pixel block;
generating a prediction signal in accordance with the decided coding mode for every multi-pixel block;
subtracting the prediction signal from a picture taken from a third viewpoint to generate a residual signal for every multi-pixel block, the third viewpoint being different from the first and second viewpoints; and
encoding a signal representative of the decided coding mode and the residual signal to generate encoded data representing the picture taken from the third viewpoint and containing the signal representative of the decided coding mode.

4. An apparatus as recited in claim 1, further comprising a buffer memory for storing the first and second decoded pictures.

5. A method as recited in claim 2, further comprising the step of storing the first and second decoded pictures in a buffer memory.

6. A computer program as recited in claim 3, further comprising the step of storing the first and second decoded pictures in a buffer memory.

7. An apparatus as recited in claim 1, wherein the different coding modes include coding modes performing motion-compensated prediction for every multi-pixel block.

8. A method as recited in claim 2, wherein the different coding modes include coding modes performing motion-compensated prediction for every multi-pixel block.

9. A computer program as recited in claim 3, wherein the different coding modes include coding modes performing motion-compensated prediction for every multi-pixel block.

10. An apparatus as recited in claim 1, wherein the different coding modes include coding modes performing disparity-compensated prediction for every multi-pixel block.

11. A method as recited in claim 2, wherein the different coding modes include coding modes performing disparity-compensated prediction for every multi-pixel block.

12. A computer program as recited in claim 3, wherein the different coding modes include coding modes performing disparity-compensated prediction for every multi-pixel block.

13. An apparatus as recited in claim 1, wherein the different coding modes include coding modes which use multi-pixel blocks of different sizes respectively.

14. A method as recited in claim 2, wherein the different coding modes include coding modes which use multi-pixel blocks of different sizes respectively.

15. A computer program as recited in claim 3, wherein the different coding modes include coding modes which use multi-pixel blocks of different sizes respectively.

16. An apparatus as recited in claim 1, wherein the different coding modes include coding modes performing a process of weighted-averaging view interpolation and motion-compensated prediction.

17. A method as recited in claim 2, wherein the different coding modes include coding modes performing a process of weighted-averaging view interpolation and motion-compensated prediction.

18. A computer program as recited in claim 3, wherein the different coding modes include coding modes performing a process of weighted-averaging view interpolation and motion-compensated prediction.

19. An apparatus as recited in claim 1, wherein the different coding modes include coding modes performing a process of weighted-averaging view interpolation and disparity-compensated prediction.

20. A method as recited in claim 2, wherein the different coding modes include coding modes performing a process of weighted-averaging view interpolation and disparity-compensated prediction.

21. A computer program as recited in claim 3, wherein the different coding modes include coding modes performing a process of weighted-averaging view interpolation and disparity-compensated prediction.

22. An apparatus for decoding encoded data representing pictures taken from multiple viewpoints, comprising:
first means for decoding encoded data representative of a picture taken from a first viewpoint to generate a first decoded picture;
second means for decoding encoded data representative of a picture taken from a second viewpoint to generate a second decoded picture, the second viewpoint being different from the first viewpoint;
third means for decoding encoded data containing a residual signal representative of a picture taken from a third viewpoint to generate a decoded residual signal, the third viewpoint being different from the first and second viewpoints;
fourth means for decoding encoded data containing a signal representative of a decided coding mode which has been decided from different coding modes to detect the decided coding mode for every multi-pixel block;
fifth means for performing view interpolation responsive to the first decoded picture generated by the first means and the second decoded picture generated by the second means to generate a view-interpolated signal for every multi-pixel block when the decided coding mode indicates use of view interpolation;
sixth means for generating a prediction signal on the basis of the view-interpolated signal generated by the fifth means in accordance with the decided coding mode for every multi-pixel block; and
seventh means for superimposing the decoded residual signal generated by the third means on the prediction signal generated by the sixth means to generate a third decoded picture equivalent to the picture taken from the third viewpoint.

23. A method of decoding encoded data representing pictures taken from multiple viewpoints, comprising the steps of:
decoding encoded data representative of a picture taken from a first viewpoint to generate a first decoded picture;
decoding encoded data representative of a picture taken from a second viewpoint to generate a second decoded picture, the second viewpoint being different from the first viewpoint;
decoding encoded data containing a residual signal representative of a picture taken from a third viewpoint to generate a decoded residual signal, the third viewpoint being different from the first and second viewpoints;
decoding encoded data containing a signal representative of a decided coding mode which has been decided from different coding modes to detect the decided coding mode for every multi-pixel block;
performing view interpolation responsive to the first decoded picture and the second decoded picture to generate a view-interpolated signal for every multi-pixel block when the decided coding mode indicates use of view interpolation;
generating a prediction signal on the basis of the view-interpolated signal in accordance with the decided coding mode for every multi-pixel block; and
superimposing the decoded residual signal on the generated prediction signal to generate a third decoded picture equivalent to the picture taken from the third viewpoint.

24. A computer program in a computer readable medium, comprising the steps of:
decoding encoded data representative of a picture taken from a first viewpoint to generate a first decoded picture;
decoding encoded data representative of a picture taken from a second viewpoint to generate a second decoded picture, the second viewpoint being different from the first viewpoint;
decoding encoded data containing a residual signal representative of a picture taken from a third viewpoint to generate a decoded residual signal, the third viewpoint being different from the first and second viewpoints;
decoding encoded data containing a signal representative of a decided coding mode which has been decided from different coding modes to detect the decided coding mode for every multi-pixel block;
performing view interpolation responsive to the first decoded picture and the second decoded picture to generate a view-interpolated signal for every multi-pixel block when the decided coding mode indicates use of view interpolation;
generating a prediction signal on the basis of the view-interpolated signal in accordance with the decided coding mode for every multi-pixel block; and
superimposing the decoded residual signal on the generated prediction signal to generate a third decoded picture equivalent to the picture taken from the third viewpoint.

25. An apparatus as recited in claim 22, further comprising a buffer memory for storing the first and second decoded pictures.

26. A method as recited in claim 23, further comprising the step of storing the first and second decoded pictures in a buffer memory.

27. A computer program as recited in claim 24, further comprising the step of storing the first and second decoded pictures in a buffer memory.

28. An apparatus as recited in claim 22, wherein the different coding modes include coding modes performing motion-compensated prediction for every multi-pixel block.

29. A method as recited in claim 23, wherein the different coding modes include coding modes performing motion-compensated prediction for every multi-pixel block.

30. A computer program as recited in claim 24, wherein the different coding modes include coding modes performing motion-compensated prediction for every multi-pixel block.

31. An apparatus as recited in claim 22, wherein the different coding modes include coding modes performing disparity-compensated prediction for every multi-pixel block.

32. A method as recited in claim 23, wherein the different coding modes include coding modes performing disparity-compensated prediction for every multi-pixel block.

33. A computer program as recited in claim 24, wherein the different coding modes include coding modes performing disparity-compensated prediction for every multi-pixel block.

34. An apparatus as recited in claim 22, wherein the different coding modes include coding modes which use multi-pixel blocks of different sizes respectively.

35. A method as recited in claim 23, wherein the different coding modes include coding modes which use multi-pixel blocks of different sizes respectively.

36. A computer program as recited in claim 24, wherein the different coding modes include coding modes which use multi-pixel blocks of different sizes respectively.

37. An apparatus as recited in claim 22, wherein the different coding modes include coding modes performing a process of weighted-averaging view interpolation and motion-compensated prediction.

38. A method as recited in claim 23, wherein the different coding modes include coding modes performing a process of weighted-averaging view interpolation and motion-compensated prediction.

39. A computer program as recited in claim 24, wherein the different coding modes include coding modes performing a process of weighted-averaging view interpolation and motion-compensated prediction.

40. An apparatus as recited in claim 22, wherein the different coding modes include coding modes performing a process of weighted-averaging view interpolation and disparity-compensated prediction.

41. A method as recited in claim 23, wherein the different coding modes include coding modes performing a process of weighted-averaging view interpolation and disparity-compensated prediction.

42. A computer program as recited in claim 24, wherein the different coding modes include coding modes performing a process of weighted-averaging view interpolation and disparity-compensated prediction.
